(19) United States
(12) Patent Application Publication
(10) Pub. No.: US 2026/0036796 A1
(43) Pub. Date: Feb. 5, 2026

(54) VARIABLE MAGNIFICATION OPTICAL SYSTEM, OPTICAL DEVICE, AND METHOD FOR MANUFACTURING VARIABLE MAGNIFICATION OPTICAL SYSTEM

(71) Applicant: NIKON CORPORATION, Tokyo (JP)

(72) Inventor: Fumiaki OHTAKE, Tokyo (JP)

(21) Appl. No.: 19/354,909

(22) Filed: Oct. 10, 2025

Related U.S. Application Data
(63) Continuation of application No. PCT/JP2024/013456, filed on Apr. 1, 2024.

(30) Foreign Application Priority Data
Apr. 13, 2023 (JP) 2023-065718

(51) Int. Cl. G02B 15/14

(52) U.S. Cl. CPC G02B 15/1465

(57) ABSTRACT

A variable magnification optical system including, in order from the object side, a first negative lens group having negative refractive power and a rear group including a plurality of lens groups is configured so that at varying magnification, the first negative lens group being fixed with respect to the image plane and the spacings between adjacent lens groups being varied, an aperture stop being disposed closer to the image plane side than the first negative lens group, a second negative lens group disposed adjacent to the image plane side of the aperture stop among the plurality of lens groups included in the rear group having negative refractive power, and that the following conditional expression is satisfied:

0.00<fA/fCα<0.30

where fA is the focal length of the first negative lens group, and fCα is the focal length of the second negative lens group.

### CROSS-REFERENCE TO RELATED APPLICATIONS

This application is a continuation of International Patent Application No. PCT/JP2024/013456 filed Apr. 1, 2024, which claims priority from Japanese Patent Application No. 2023-065718 filed Apr. 13, 2023, which are incorporated herein by reference.

### FIELD

The present disclosure relates to a variable magnification optical system, an optical device, and a method for manufacturing a variable magnification optical system.

### BACKGROUND

A variable magnification optical system used in optical devices such as cameras for photographs, electronic still cameras, and video cameras, has been proposed (see, e.g., Japanese Unexamined Patent Publication No. 2021-196573).

### SUMMARY

A variable magnification optical system of the present disclosure includes, in order from the object side, a first negative lens group having negative refractive power and a rear group including a plurality of lens groups, wherein at varying magnification, the first negative lens group being fixed with respect to the image plane and the spacings between adjacent lens groups being varied, an aperture stop being disposed closer to the image plane side than the first negative lens group, and a second negative lens group disposed adjacent to the image plane side of the aperture stop among the plurality of lens groups included in the rear group having negative refractive power. The variable magnification optical system satisfies the following conditional expression.

0.00<fA/fCα<0.30

where
fA: the focal length of the first negative lens group
fCα: the focal length of the second negative lens group

A variable magnification optical system of the present disclosure includes, in order from the object side, a first negative lens group having negative refractive power and a rear group including a plurality of lens groups, wherein at varying magnification, the first negative lens group being fixed with respect to the image plane and the spacings between adjacent lens groups being varied, and a third negative lens group being disposed closest to the object side among one or more lens groups having negative refractive power and disposed closer to the image plane side than a first positive lens group having positive refractive power and disposed closest to the object side in the plurality of lens groups included in the rear group. The variable magnification optical system satisfies the following conditional expression.

0.00<fA/fCβ<0.30

where
fA: the focal length of the first negative lens group
fCβ: the focal length of the third negative lens group

A method for manufacturing a variable magnification optical system of the present disclosure includes configuring a variable magnification optical system including, in order from an object side, a first negative lens group having negative refractive power and a rear group having a plurality of lens groups, wherein, at varying magnification, the first negative lens group being fixed with respect to the image plane and the spacings between adjacent lens groups being varied, an aperture stop being disposed closer to the image plane side than the first negative lens group, and a second negative lens group having negative refractive power and disposed adjacent to the image plane side of the aperture stop among the plurality of lens groups included in the rear group, and the following conditional expression is satisfied.

0.00<fA/fCα<0.30

where
fA: the focal length of the first negative lens group
fCα: the focal length of the second negative lens group

### BRIEF DESCRIPTION OF THE DRAWINGS

FIG. 1 is a cross-sectional view of a variable magnification optical system of a first example focusing on an object at infinity in a wide-angle end state.

FIG. 2A shows aberrations of the variable magnification optical system of the first example focusing on an object at infinity in the wide-angle end state, and FIG. 2B shows aberrations of the variable magnification optical system of the first example focusing on an object at infinity in the telephoto end state.

FIG. 3 is a cross-sectional view of a variable magnification optical system of a second example focusing on an object at infinity in a wide-angle end state.

FIG. 4A shows aberrations of the variable magnification optical system of the second example focusing on an object at infinity in the wide-angle end state, and FIG. 4B shows aberrations of the variable magnification optical system of the second example focusing on an object at infinity in the telephoto end state.

FIG. 5 is a cross-sectional view of a variable magnification optical system of a third example focusing on an object at infinity in a wide-angle end state.

FIG. 6A shows aberrations of the variable magnification optical system of the third example focusing on an object at infinity in the wide-angle end state, and FIG. 6B shows aberrations of the variable magnification optical system of the third example focusing on an object at infinity in the telephoto end state.

FIG. 7 is a cross-sectional view of a variable magnification optical system of a fourth example focusing on an object at infinity in a wide-angle end state.

FIG. 8A shows aberrations of the variable magnification optical system of the fourth example focusing on an object at infinity in the wide-angle end state, and FIG. 8B shows aberrations of the variable magnification optical system of the fourth example focusing on an object at infinity in the telephoto end state.

FIG. 9 is a cross-sectional view of a variable magnification optical system of a fifth example focusing on an object at infinity in a wide-angle end state.

FIG. 10A shows aberrations of the variable magnification optical system of the fifth example focusing on an object at infinity in the wide-angle end state, and FIG. 10B shows aberrations of the variable magnification optical system of the fifth example focusing on an object at infinity in the telephoto end state.

FIG. 11 is a cross-sectional view of a variable magnification optical system of a sixth example focusing on an object at infinity in a wide-angle end state.

FIG. 12A shows aberrations of the variable magnification optical system of the sixth example focusing on an object at infinity in the wide-angle end state, and FIG. 12B shows aberrations of the variable magnification optical system of the sixth example focusing on an object at infinity in the telephoto end state.

FIG. 13 is a schematic diagram of a camera including the variable magnification optical system of the present embodiment.

FIG. 14 is a flowchart schematically showing a first manufacturing method of the variable magnification optical system according to the present embodiment.

FIG. 15 is a flowchart schematically showing a second manufacturing method of the variable magnification optical system according to the present embodiment.

### DESCRIPTION OF EMBODIMENTS

Hereinafter, a variable magnification optical system, an optical apparatus, and a manufacturing method of the variable magnification optical system according to an embodiment of the present application will be described.

A variable magnification optical system of the present embodiment includes, in order from an object side, a first negative lens group having negative refractive power and a rear group including a plurality of lens groups, wherein at varying magnification, the first negative lens group being fixed with respect to the image plane, the spacings between adjacent lens groups being varied, an aperture stop being disposed closer to the image plane side than the first negative lens group, and a second negative lens group disposed adjacent to the image plane side of the aperture stop among the plurality of lens groups included in the rear group having negative refractive power; the variable magnification optical system satisfies the following conditional expression:

0.00<fA/fCα<0.30 (1-1)

where
fA: the focal length of the first negative lens group
fCα: the focal length of the second negative lens group.

The variable magnification optical system of the present embodiment can appropriately correct aberrations including spherical aberration at varying magnification, by including a first negative lens group having negative refractive power and a rear group including a plurality of lens groups, wherein an aperture stop being disposed closer to the image plane side than the first negative lens group, and a second negative lens group having negative refractive power being disposed adjacent to the image plane side of the aperture stop.

Conditional Expression (1-1) restricts the ratio between the focal lengths of the first and second negative lens groups. The variable magnification optical system of the present embodiment satisfying conditional expression (1-1) can appropriately correct aberrations including spherical aberration while suppressing enlargement of the variable magnification optical system.

If the value of conditional expression (1-1) exceeds the upper limit in the variable magnification optical system of the present embodiment, the first negative lens group will have too weak refractive power, making the variable magnification optical system larger.

In the variable magnification optical system of the present embodiment, the effect of the present embodiment can be ensured by setting the upper limit of conditional expression (1-1) to 0.30. To further ensure the effect of the present embodiment, the upper limit of conditional expression (1-1) is preferably set to 0.28, 0.26, 0.25 or 0.24, more preferably to 0.23.

If the value of conditional expression (1-1) falls below the lower limit in the variable magnification optical system of the present embodiment, the second negative lens group will have too weak refractive power, making it difficult to appropriately correct aberrations including spherical aberration.

In the variable magnification optical system of the present embodiment, the effect of the present embodiment can be ensured by setting the lower limit of conditional expression (1-1) to 0.00. To further ensure the effect of the present embodiment, the lower limit of conditional expression (1-1) is preferably set to 0.02, 0.04, 0.06 or 0.08, more preferably to 0.10.

In the variable magnification optical system of the present embodiment, at least one lens group among the lens groups disposed closer to the image plane side than the second negative lens group preferably moves at focusing.

Such a configuration reduces variations in aberrations including spherical aberration at varying magnification and suppresses fluctuation of the angle of view (so-called “breathing”) at focusing.

The variable magnification optical system of the present embodiment preferably satisfies the following conditional expression:

0.90<MVGCα/MVGE<1.50 (2-1)

where
MVGCα: the amount of movement of the second negative lens group focusing on infinity at varying magnification from the wide-angle end to the telephoto end
MVGE: the amount of movement of the final negative lens group having the negative refractive power disposed closest to the image plane among the plurality of lens groups included in the rear group focusing on infinity at varying magnification from the wide-angle end to the telephoto end.

Conditional Expression (2-1) restricts the ratio between the amounts of movement of the second negative lens group and the final negative lens group focusing on infinity at varying magnification from the wide-angle end to the telephoto end. In the variable magnification optical system of the present embodiment satisfying the conditional expression (2-1), the ratio of the amounts of movement of the second negative lens group and the final negative lens group at varying magnification from the wide-angle end to the telephoto end will be close to 1, making it possible to correct the field curvature preferably in the overall range of variable magnification.

If the value of conditional expression (2-1) exceeds the upper limit in the variable magnification optical system of the present embodiment, it will be difficult to appropriately correct field curvature in the overall range of variable magnification.

In the variable magnification optical system of the present embodiment, the effect of the present embodiment can be ensured by setting the upper limit of conditional expression (2-1) to 1.50. To further ensure the effect of the present embodiment, the upper limit of conditional expression (2-1) is preferably set to 1.45, 1.40, 1.37 or 1.34, more preferably to 1.30.

If the value of conditional expression (2-1) is below the lower limit in the variable magnification optical system of the present embodiment, it will be difficult to appropriately correct field curvature in the overall range of variable magnification.

In the variable magnification optical system of the present embodiment, the effect of the present embodiment can be ensured by setting the lower limit of conditional expression (2-1) to 0.90. To further ensure the effect of the present embodiment, the lower limit of conditional expression (2-1) is preferably set to 0.92, 0.94 or 0.96, more preferably to 0.98. In the variable magnification optical system of the present embodiment, the second negative lens group preferably has a positive lens Cαp satisfying the following conditional expression:

0.020<PgFCαp−0.64435+0.00168*νdCαp (3-1)

where
PgFCαp: the partial dispersion ratio of the positive lens Cαp defined by the following expression:

PgFCαp=(ngCαp−nFCαp)/(nFCαp−nCCαp)

where ngCαp, nFCαp, and nCCαp denote the refractive indices of the positive lens Cαp at g-line, F-line, and C-line, respectively
νdCαp: the Abbe number based on d-line of the positive lens Cαp.

The variable magnification optical system of the present embodiment including the second negative lens group having the positive lens Cαp satisfying Conditional Expression (3-1) can satisfactory correct the second-order dispersion of the chromatic aberration of magnification.

If the value of conditional expression (3-1) falls below the lower limit in the variable magnification optical system of the present embodiment, it will be difficult to appropriately correct the secondary dispersion of lateral chromatic aberration.

In the variable magnification optical system of the present embodiment, the effect of the present embodiment can be ensured by setting the lower limit of conditional expression (3-1) to 0.020. To further ensure the effect of the present embodiment, the lower limit of conditional expression (3-1) is preferably set to 0.022 or 0.024, more preferably to 0.026.

The variable magnification optical system of the present embodiment preferably satisfies the following conditional expression:

0.045<fw/(−fCα)<0.140 (4-1)

where
Fw: the focal length of the variable magnification optical system at wide-angle end state.

Conditional Expression (4-1) restricts the ratio between the focal lengths of the variable magnification optical system and the second negative lens group in a wide-angle end state. The variable magnification optical system of the present embodiment satisfying conditional expression (4-1) can appropriately correct aberrations including field curvature, distortion, and spherical aberration, while suppressing an increase in the weight of the variable magnification optical system.

If the value of conditional expression (4-1) exceeds the upper limit in the variable magnification optical system of the present embodiment, the refractive power of the second negative lens group will be too strong, making it difficult to appropriately correct aberrations including field curvature and distortion.

In the variable magnification optical system of the present embodiment, the effect of the present embodiment can be ensured by setting the upper limit of conditional expression (4-1) to 0.140. To further ensure the effect of the present embodiment, the upper limit of conditional expression (4-1) is preferably set to 0.135, 0.130 or 0.125, more preferably to 0.122.

If the value of conditional expression (4-1) falls below the lower limit in the variable magnification optical system of the present embodiment, the refractive power of the second negative lens group will be too weak, making it difficult to appropriately correct aberrations including spherical aberration. Further, the diameter of lenses in the rear group will increase, making the weight of the variable magnification optical system increase.

In the variable magnification optical system of the present embodiment, the effect of the present embodiment can be ensured by setting the lower limit of conditional expression (4-1) to 0.045. To further ensure the effect of the present embodiment, the lower limit of conditional expression (4-1) is preferably set to 0.050, 0.055 or 0.058, more preferably to 0.060.

In the variable magnification optical system of the present embodiment, a lens group disposed between the first negative lens group and the aperture stop has positive combined refractive power in the wide-angle end state.

Such a configuration enables the variable magnification optical system of the present embodiment to preferably correct aberrations including field curvature and distortion.

The variable magnification optical system of the present embodiment preferably satisfies the following conditional expression:

0.30<STLw/TLw<0.50 (5)

where
STLw: the distance on the optical axis from the aperture stop to the image plane in the wide-angle end state
TLw: the distance on the optical axis from the lens surface closest to the object to the image plane in the wide-angle end state.

Conditional expression (5) restricts the ratio between the distance on the optical axis from the aperture stop to the image plane and the distance on the optical axis from the lens surface closest to the object side to the image plane in the wide-angle end state. The variable magnification optical system of the present embodiment satisfying conditional expression (5) can appropriately correct aberrations including coma aberration in the overall range of variable magnification.

If the value of conditional expression (5) exceeds the upper limit in the variable magnification optical system of the present embodiment, the position of the aperture stop will be too close to the object side, making it difficult to appropriately correct aberrations including coma aberration in a wide-angle side in the variable magnification.

In the variable magnification optical system of the present embodiment, the effect of the present embodiment can be ensured by setting the upper limit of conditional expression (5) to 0.50. To further ensure the effect of the present embodiment, the upper limit of conditional expression (5) is preferably set to 0.48 or 0.46, more preferably to 0.42.

If the value of conditional expression (5) falls below the lower limit in the variable magnification optical system of the present embodiment, the position of the aperture stop will be too close to the image plane side, making it difficult to appropriately correct aberrations including coma aberration in a telephoto side at the variable magnification.

In the variable magnification optical system of the present embodiment, the effect of the present embodiment can be ensured by setting the lower limit of conditional expression (5) to 0.30. To further ensure the effect of the present embodiment, the lower limit of conditional expression (5) is preferably set to 0.32, 0.34, 0.36 or 0.38, more preferably to 0.40.

A variable magnification optical system of the present embodiment includes, in order from the object side, a first negative lens group having negative refractive power, and a rear group including a plurality of lens groups, wherein at varying magnification, the first negative lens group being fixed with respect to the image plane and the spacings between adjacent lens groups being varied, and a third negative lens group being disposed closest to the object side among one or more lens groups having negative refractive power and disposed closer to the image plane side than the first positive lens group having positive refractive power and disposed closest to the object side in the plurality of lens groups included in the rear group; the variable magnification optical system satisfies the following conditional expression:

0.00<fA/fCβ<0.30 (1-2)

where
fA: the focal length of the first negative lens group
fCβ: the focal length of the third negative lens group.

The variable magnification optical system of the present embodiment can appropriately correct aberrations including spherical aberration at varying magnification by including a first negative lens group having negative refractive power and a rear group having a plurality of lens groups, and having a third negative lens group disposed closest to the object side among one or more lens groups having negative refractive power and disposed closer to the image plane side than the first positive lens group having positive refractive power and disposed closest to the object side among the plurality of lens groups included in the rear group.

Conditional Expression (1-2) restricts the ratio between the focal lengths of the first negative lens group and the third negative lens group. The variable magnification optical system of the present embodiment satisfying conditional expression (1-2) can appropriately correct aberrations including spherical aberration while suppressing enlargement of the variable magnification optical system.

If the value of conditional expression (1-2) in the variable magnification optical system of the present embodiment exceeds the upper limit, the refractive power of the first negative lens group will be too weak, making the variable magnification optical system larger.

In the variable magnification optical system of the present embodiment, the effect of the present embodiment can be ensured by setting the upper limit of conditional expression (1-2) to 0.30. To further ensure the effect of the present embodiment, the upper limit of conditional expression (1-2) is preferably set to 0.28, 0.26, 0.25 or 0.24, more preferably to 0.23.

If the value of conditional expression (1-2) falls below the lower limit in the variable magnification optical system of the present embodiment, the refractive power of the third negative lens group will be too weak, making it difficult to appropriately correct aberrations including spherical aberration.

In the variable magnification optical system of the present embodiment, the effect of the present embodiment can be ensured by setting the lower limit of conditional expression (1-2) to 0.00. To further ensure the effect of the present embodiment, the lower limit of conditional expression (1-2) is preferably set to 0.02, 0.04, 0.06 or 0.08, more preferably to 0.10.

In the variable magnification optical system of the present embodiment, at least one lens group among the lenses disposed closer to the image plane side than the third negative lens group preferably moves at focusing.

Such a configuration reduces variations in aberrations including spherical aberration at varying magnification and suppresses fluctuation of the angle of view (so-called “breathing”) at focusing.

The variable magnification optical system of the present embodiment preferably satisfies the following conditional expression:

0.90<MVGCβ/MVGE<1.50 (2-2)

where
MVGCβ: the amount of movement of the third negative lens group focusing on infinity at varying magnification from the wide-angle end state to the telephoto end state
MVGE: the mount of movement of the final negative lens group focusing on infinity at varying magnification from the wide-angle end state to the telephoto end state.

Conditional Expression (2-2) restricts the ratio between the amounts of movement of the third negative lens group and the final negative lens group focusing on infinity at varying magnification from the wide-angle end state to the telephoto end state. In the variable magnification optical system of the present embodiment satisfying the conditional expression (2-2), the ratio of the amounts of movement of the third negative lens group and the final negative lens group at varying magnification from the wide-angle end state to the telephoto end state will be close to 1, making it possible to correct the field curvature preferably in the overall range of variable magnification.

If the value of conditional expression (2-2) exceeds the upper limit in the variable magnification optical system of the present embodiment, it will be difficult to appropriately correct field curvature in the overall range of variable magnification.

In the variable magnification optical system of the present embodiment, the effect of the present embodiment can be ensured by setting the upper limit of conditional expression (2-2) to 1.50. To further ensure the effect of the present embodiment, the upper limit of conditional expression (2-2) is preferably set to 1.45, 1.40, 1.37 or 1.34, more preferably to 1.30.

If the value of conditional expression (2-2) falls below the lower limit in the variable magnification optical system of the present embodiment, it will be difficult to appropriately correct the field curvature in the overall range of variable magnification.

In the variable magnification optical system of the present embodiment, the effect of the present embodiment can be ensured by setting the lower limit of conditional expression (2-2) to 0.90. To further ensure the effect of the present embodiment, the lower limit of conditional expression (2-2) is preferably set to 0.92, 0.94 or 0.96, more preferably to 0.98.

In the variable magnification optical system of the present embodiment, the second negative lens group preferably has a positive lens Cβp satisfying the following conditional expression:

0.020<PgFCβp−0.64435+0.00168*νdCβp

where
PgFCβp: the partial dispersion ratio of the positive lens Cβp, defined by the following expression:

PgFCβp=(ngCβp−nFCβp)/(nFCβp−nCCβp)

where ngCβp, nFCβp, and nCCβp denote the refractive indices of the positive lens Cβp at the g-line, the F-line, the C-line, respectively
νdCβp: the Abbe number based on d-line of the positive lens Cβp.

The variable magnification optical system of the present embodiment including the third negative lens group having the positive lens Cβp satisfying Conditional Expression (3-2) can satisfactorily correct the second-order dispersion of the chromatic aberration of magnification.

If the value of conditional expression (3-2) falls below the lower limit in the variable magnification optical system of the present embodiment, it will be difficult to appropriately correct the secondary dispersion of the lateral chromatic aberration.

In the variable magnification optical system of the present embodiment, the effect of the present embodiment can be ensured by setting the lower limit of conditional expression (3-2) to 0.020. To further ensure the effect of the present embodiment, the lower limit of conditional expression (3-2) is preferably set to 0.022 or 0.024, more preferably to 0.026.

The variable magnification optical system of the present embodiment preferably satisfies the following conditional expression:

0.045<fw/(−fCβ)<0.140 (4-2)

where
Fw: the focal length of variable magnification optical system in the wide-angle end state.

Conditional Expression (4-2) restricts the ratio between the focal lengths of the variable magnification optical system and the second negative lens group in the wide-angle end state. The variable magnification optical system of the present embodiment satisfying conditional expression (4-2) can appropriately correct aberrations including field curvature, distortion, and spherical aberration while suppressing an increase in the weight of the variable magnification optical system.

If the value of conditional expression (4-2) exceeds the upper limit in the variable magnification optical system of the present embodiment, the refractive power of the third negative lens group will be too strong, making it difficult to appropriately correct aberrations including field curvature and distortion.

In the variable magnification optical system of the present embodiment, the effect of the present embodiment can be ensured by setting the upper limit of conditional expression (4-2) to 0.140. To further ensure the effect of the present embodiment, the upper limit of conditional expression (4-2) is preferably set to 0.135, 0.130 or 0.125, more preferably to 0.122.

If the value of conditional expression (4-2) falls below the lower limit in the variable magnification optical system of the present embodiment, the refractive power of the third negative lens group will be too weak, making it difficult to appropriately correct aberrations including spherical aberration. Further, the diameter of lenses in the rear group will increase, making the weight of the variable magnification optical system increase.

In the variable magnification optical system of the present embodiment, the effect of the present embodiment can be ensured by setting the lower limit of conditional expression (4-2) to 0.045. To further ensure the effect of the present embodiment, the lower limit of conditional expression (4-2) is preferably set to 0.050, 0.055 or 0.058, more preferably to 0.060.

In the variable magnification optical system of the present embodiment, the plurality of lens groups included in the rear group preferably include a first positive lens group having positive refractive power and disposed closest to the object side and a second positive lens group having positive refractive power and disposed adjacent to the image plane side of the first positive lens group, and the following conditional expression is satisfied:

1.40<fB1/fB2<3.00 (6)

where
fB1: the focal length of the first positive lens group
fB2: the focal length of the second positive lens group.

Conditional Expression (6) restricts the ratio between the focal lengths of the first positive lens group and the second positive lens group. The variable magnification optical system of the present embodiment satisfying conditional expression (6) can appropriately correct aberrations including spherical aberration and coma aberration in the overall range of variable magnification.

If the value of conditional expression (6) exceeds the upper limit in the variable magnification optical system of the present embodiment, the refractive power of the second positive lens group will be too strong, making it difficult to appropriately correct aberrations including spherical aberration in a telephoto side.

In the variable magnification optical system of the present embodiment, the effect of the present embodiment can be ensured by setting the upper limit of conditional expression (6) to 3.00. To further ensure the effect of the present embodiment, the upper limit of conditional expression (6) is preferably set to 2.90, 2.80 or 2.75, more preferably to 2.65.

If the value of conditional expression (6) falls below the lower limit in the variable magnification optical system of the present embodiment, the refractive power of the first positive lens group will be too strong, making it difficult to appropriately correct aberrations including coma aberration at a wide-angle side.

In the variable magnification optical system of the present embodiment, the effect of the present embodiment can be ensured by setting the lower limit of conditional expression (6) to 1.40. To further ensure the effect of the present embodiment, the lower limit of conditional expression (6) is preferably set to 1.45, 1.50, 1.55 or 1.60, more preferably to 1.63.

The variable magnification optical system of the present embodiment preferably satisfies the following conditional expression:

1.00<−fA/fARw<1.60 (7)

where
fARw: the combined focal length of the rear group in the wide-angle end state.

Conditional Expression (7) restricts the ratio between the focal lengths of the first negative lens group and the rear group in a wide-angle end state. The variable magnification optical system of the present embodiment satisfying conditional expression (7) can appropriately correct aberrations including field curvature and distortion while suppressing enlargement of the variable magnification optical system.

If the value of conditional expression (7) exceeds the upper limit in the variable magnification optical system of the present embodiment, the refractive power of the first negative lens group will be too weak, making the variable magnification optical system larger.

In the variable magnification optical system of the present embodiment, the effect of the present embodiment can be ensured by setting the upper limit of conditional expression (7) to 1.60. To further ensure the effect of the present embodiment, the upper limit of conditional expression (7) is preferably set to 1.55, 1.50, 1.48 or 1.45, more preferably to 1.42.

If the value of conditional expression (7) falls below the lower limit in the variable magnification optical system of the present embodiment, the refractive power of the first negative lens group will be too strong, making it difficult to appropriately correct aberrations including field curvature and distortion.

In the variable magnification optical system of the present embodiment, the effect of the present embodiment can be ensured by setting the lower limit of conditional expression (7) to 1.00. To further ensure the effect of the present embodiment, the lower limit of conditional expression (7) is preferably set to 1.03, 1.06, 1.10 or 1.13, more preferably to 1.16.

The variable magnification optical system of the present embodiment preferably satisfies the following conditional expression:

0.50<fA/fE<1.20 (8)

where
fE: the focal length of the final negative lens group having the negative refractive power disposed closest to the image among the plurality of lens groups included in the rear group.

Conditional expression (8) restricts the ratio between the focal lengths of the first negative lens group and the final negative lens group. The variable magnification optical system of the present embodiment satisfying conditional expression (8) can appropriately correct aberrations including field curvature and distortion while suppressing enlargement of the variable magnification optical system.

If the value of conditional expression (8) exceeds the upper limit in the variable magnification optical system of the present embodiment, the refractive power of the first negative lens group will be too weak, making the variable magnification optical system larger.

In the variable magnification optical system of the present embodiment, the effect of the present embodiment can be ensured by setting the upper limit of conditional expression (8) to 1.20. To further ensure the effect of the present embodiment, the upper limit of conditional expression (8) is preferably set to 1.15, 1.10, 1.05 or 1.00, more preferably to 0.98.

If the value of conditional expression (8) falls below the lower limit in the variable magnification optical system of the present embodiment, the refractive power of the first negative lens group will be too strong, making it difficult to appropriately correct aberrations including field curvature and distortion.

In the variable magnification optical system of the present embodiment, the effect of the present embodiment can be ensured by setting the lower limit of conditional expression (8) to 0.50. To further ensure the effect of the present embodiment, the lower limit of conditional expression (8) is preferably set to 0.55, 0.60, 0.63 or 0.66, more preferably to 0.68.

In the variable magnification optical system of the present embodiment, it is preferable that two lens groups having positive refractive power among the plurality of lens groups included in the rear group move at focusing, and the following conditional expression is satisfied:

0.40<fF1/fF2<1.20 (9)

where
fF1: the focal length of a lens group on the object side of the two lens groups
fF2: the focal length of a lens group on the image plane side of the two lens groups.

Conditional Expression (9) restricts the ratio between the focal lengths of the lens group disposed on the object side and the lens group disposed on the image plane side of the two lens groups having positive refractive power and moving at focusing among the plurality of lens groups included in the rear group. The variable magnification optical system of the present embodiment satisfying conditional expression (9) can appropriately correct aberrations including field curvature and coma aberration at focusing nearby.

If the value of conditional expression (9) exceeds the upper limit in the variable magnification optical system of the present embodiment, the refractive power of the lens group disposed on the object side of the two lens groups will be too low, making it difficult to appropriately correct the field curvature at focusing nearby.

In the variable magnification optical system of the present embodiment, the effect of the present embodiment can be ensured by setting the upper limit of conditional expression (9) to 1.20. To further ensure the effect of the present embodiment, the upper limit of conditional expression (9) is preferably set to 1.15, 1.10, 1.05 or 1.00, more preferably to 0.95.

If the value of conditional expression (9) falls below the lower limit in the variable magnification optical system of the present embodiment, the refractive power of the lens group disposed on the object side of the two lens groups will be too strong, making it difficult to appropriately correct the coma aberration at focusing nearby.

In the variable magnification optical system of the present embodiment, the effect of the present embodiment can be ensured by setting the lower limit of conditional expression (9) to 0.40. To further ensure the effect of the present embodiment, the lower limit of conditional expression (9) is preferably set to 0.44, 0.48, 0.52 or 0.56, more preferably to 0.60.

The variable magnification optical system of the present embodiment preferably satisfies the following conditional expression:

0.60<MVF1w/MVF2w<1.70 (10)

where
MVF1w: the amount of movement of a lens group on the object side of two lens groups moving at focusing among the plurality of lens groups included in a rear group at focusing from infinity to nearby in the wide-angle end state
MVF2w: the amount of movement of the lens group on the image plane side of two lens groups moving at focusing among the plurality of lens groups included in the rear group at focusing from infinity to nearby in the wide-angle end state.

Conditional Expression (10) restricts a ratio between the amounts of movement of the lens group on the object side and the lens group on the image plane side of the two lens groups moving at focusing among the plurality of lens groups included in the rear group focusing from infinity to nearby in the wide-angle end state. The variable magnification optical system of the present embodiment satisfying conditional expression (10) can appropriately correct aberrations including field curvature. In the present disclosure, “nearby” means the shortest photographing distance.

If the value of conditional expression (10) exceeds the upper limit in the variable magnification optical system of the present embodiment, it will be difficult to appropriately correct aberrations including field curvature.

In the variable magnification optical system of the present embodiment, the effect of the present embodiment can be ensured by setting the upper limit of conditional expression (10) to 1.70. To further ensure the effect of the present embodiment, the upper limit of conditional expression (10) is preferably set to 1.65, 1.60, 1.56 or 1.52, more preferably to 1.48.

If the value of conditional expression (10) falls below the lower limit in the variable magnification optical system of the present embodiment, it will be difficult to appropriately correct aberrations including field curvature.

In the variable magnification optical system of the present embodiment, the effect of the present embodiment can be ensured by setting the lower limit of conditional expression (10) to 0.60. To further ensure the effect of the present embodiment, the lower limit of conditional expression (10) is preferably set to 0.64, 0.68, 0.72 or 0.76, more preferably to 0.80.

The variable magnification optical system of the present embodiment preferably satisfies the following conditional expression:

0.40<MVGO/MVGE<0.80 (11)

where
MVGE: the amount of movement of the final negative lens group having negative refractive power disposed closest to the image plane among the plurality of lens groups included in the rear group at varying magnification from the wide-angle end state to the telephoto end state at focusing on infinity
MVGO: the amount of movement of the lens group disposed adjacent to the object side of the final negative lens group among the plurality of lens groups included in the rear group at varying magnification from the wide-angle end state to the telephoto end state at focusing on infinity.

Conditional expression (11) restricts the ratio between the amounts of movement of the final negative lens group and the lens group disposed adjacent to the object side of the final negative lens group at varying magnification from the wide-angle end state to the telephoto end state at focusing on infinity. The variable magnification optical system of the present embodiment satisfying conditional expression (11) can appropriately correct aberrations including coma aberration and lateral chromatic aberration in the overall range of variable magnification.

If the value of conditional expression (11) exceeds the upper limit in the variable magnification optical system of the present embodiment, the final negative lens group and the lens group adjacent to the object side of the final negative lens group will not sufficiently approach each other at varying magnification from the wide-angle end state to the telephoto end state, making it difficult to appropriately correct aberrations including coma aberration and lateral chromatic aberration in the overall range of variable magnification.

In the variable magnification optical system of the present embodiment, the effect of the present embodiment can be ensured by setting the upper limit of conditional expression (11) to 0.80. To further ensure the effect of the present embodiment, the upper limit of conditional expression (11) is preferably set to 0.77, 0.75, 0.72 or 0.70, more preferably to 0.68.

If the value of conditional expression (11) falls below the lower limit in the variable magnification optical system of the present embodiment, the final negative lens group and the lens group adjacent to the object side of the final negative lens group will be too close to each other at varying magnification from the wide-angle end state to the telephoto end state, making it difficult to appropriately correct aberrations including coma aberration and lateral chromatic aberration in the overall range of variable magnification.

In the variable magnification optical system of the present embodiment, the effect of the present embodiment can be ensured by setting the lower limit of conditional expression (11) to 0.40. To further ensure the effect of the present embodiment, the lower limit of conditional expression (11) is preferably set to 0.42 or 0.44, more preferably to 0.46.

The variable magnification optical system of the present embodiment preferably satisfies the following conditional expression:

0.40<BFw/fw<0.60 (12)

where
Bfw: the back focal length of the variable magnification optical system in the wide-angle end state
Fw: the focal length of variable magnification optical system in the wide-angle end state.

Conditional Expression (12) restricts the ratio between the back focal length and the focal length of the variable magnification optical system in the wide-angle end state. The variable magnification optical system of the present embodiment satisfying conditional expression (12) can secure a space for disposing a component between the lens disposed closest to the image plane and the image plane while suppressing enlargement of the variable magnification optical system.

If the value of conditional expression (12) exceeds the upper limit in the variable magnification optical system of the present embodiment, the back focus will be too large, making the variable magnification optical system larger.

In the variable magnification optical system of the present embodiment, the effect of the present embodiment can be ensured by setting the upper limit of conditional expression (12) to 0.60. To further ensure the effect of the present embodiment, the upper limit of conditional expression (12) is preferably set to 0.58, 0.56, 0.54 or 0.52, more preferably to 0.50.

If the value of conditional expression (12) falls below the lower limit in the variable magnification optical system of the present embodiment, the back focus will be too small, making it difficult to dispose a component between the lens disposed closest to the image plane and the image plane.

In the variable magnification optical system of the present embodiment, the effect of the present embodiment can be ensured by setting the lower limit of conditional expression (12) to 0.40. To further ensure the effect of the present embodiment, the lower limit of conditional expression (12) is preferably set to 0.42 or 0.44, more preferably to 0.46.

The variable magnification optical system of the present embodiment preferably satisfies the following conditional expression:

−3.00<(L1R2+L1R1)/(L1R2−L1R1)<−1.00 (13)

where
L1R1: the radius of curvature of the object-side lens surface of the lens disposed closest to the object side
L1R2: the radius of curvature of the image-plane-side surface of the lens disposed closest to the object side.

Conditional expression (13) restricts the shape factor of the lens disposed closest to the object side. The variable magnification optical system of the present embodiment satisfying conditional expression (13) can appropriately correct aberrations including coma aberration and field curvature.

In the variable magnification optical system of the present embodiment, the effect of the present embodiment can be ensured by setting the upper limit of conditional expression (13) to −1.00. To further ensure the effect of the present embodiment, the upper limit of conditional expression (13) is preferably set to −1.10, −1.20, −1.30 or −1.40, more preferably to −1.50.

In the variable magnification optical system of the present embodiment, the effect of the present embodiment can be ensured by setting the lower limit of conditional expression (13) to −3.00. To further ensure the effect of the present embodiment, the lower limit of conditional expression (13) is preferably set to −2.75, −2.50 or −2.25, more preferably to −2.00.

The variable magnification optical system of the present embodiment preferably satisfies the following conditional expression:

0.00<(LLR2+LLR1)/(LLR2−LLR1)<2.00 (14)

where
LLR1: the radius of curvature of the object-side surface of the lens disposed closest to the image plane side
LLR2: the radius of curvature of the image-plane-side surface of the lens disposed closest to the image plane side.

Conditional expression (14) restricts the shape factor of the lens disposed closest to the image plane side. The variable magnification optical system of the present embodiment satisfying conditional expression (14) can appropriately correct aberrations including coma aberration and field curvature.

In the variable magnification optical system of the present embodiment, the effect of the present embodiment can be ensured by setting the upper limit of conditional expression (14) to 2.00. To further ensure the effect of the present embodiment, the upper limit of conditional expression (14) is preferably set to 1.90, 1.80, 1.70 or 1.65, more preferably to 1.60.

In the variable magnification optical system of the present embodiment, the effect of the present embodiment can be ensured by setting the lower limit of conditional expression (14) to 0.00. To further ensure the effect of the present embodiment, the lower limit of conditional expression (14) is preferably set to 0.20, 0.40, 0.60 or 0.80, more preferably to 0.90.

The variable magnification optical system of the present embodiment preferably satisfies the following conditional expression:

68°<2ωw (15)

where
2ωw: the total field angle of the variable magnification optical system in the wide-angle end state.

Conditional expression (15) restricts the total field angle of the variable magnification optical system in the wide-angle end state. The variable magnification optical system of the present embodiment satisfying conditional expression (15) can obtain a large field angle.

In the variable magnification optical system of the present embodiment, the effect of the present embodiment can be ensured by setting the lower limit of conditional expression (15) to 68.00°. To further ensure the effect of the present embodiment, the upper limit of conditional expression (15) is preferably set to 72.00° or 75.00°, more preferably to 80.00°.

The variable magnification optical system of the present embodiment preferably satisfies the following conditional expression:

2ωt<40° (16)

where
2ωt: the total field angle of the variable magnification optical system in the telephoto end state.

Conditional Expression (16) restricts the total angle of view of the variable magnification optical system in the telephoto end state. The variable magnification optical system of the present embodiment satisfying conditional expression (16) can obtain a large subject image.

In the variable magnification optical system of the present embodiment, the effect of the present embodiment can be ensured by setting the upper limit of conditional expression (16) to 40.00°. To further ensure the effect of the present embodiment, the upper limit of conditional expression (16) is preferably set to 38.00° or 36.00°, more preferably to 35.00°.

In the variable magnification optical system of the present embodiment, the movement amounts of two lens groups among the plurality of lens groups included in the rear group are preferably equal at varying magnification from the wide-angle end to the telephoto end at focusing on infinity.

Such a configuration reduces the number of components for moving each lens group, enabling the variable magnification optical system of the present embodiment to be reduced in weight.

In the variable magnification optical system of the present embodiment, the first negative lens group and the lens group disposed closest to the image plane side among the plurality of lens groups included in the rear group are preferably fixed with respect to the image plane at varying magnification and focusing.

Such a configuration, which fixes the first negative lens group disposed closest to the object side and the lens group disposed closest to the image plane side, enables to secure them reliably to the lens housing, preventing the entry of foreign matter into the variable magnification optical system of the present embodiment more appropriately.

The variable magnification optical system of the present embodiment preferably satisfies the following conditional expression:

2.00<Fnot<4.00 (17)

where
Fnot: the f-number of the variable magnification optical system in the telephoto end state.

Conditional expression (17) restricts the f-number of the variable magnification optical system in the telephoto end state. The variable magnification optical system of the present embodiment satisfying conditional expression (17) can ensure brightness in the telephoto end state and can satisfactorily correct aberrations including spherical aberration.

In the variable magnification optical system of the present embodiment, the effect of the present embodiment can be ensured by setting the upper limit of conditional expression (17) to 4.00. To further ensure the effect of the present embodiment, the upper limit of conditional expression (17) is preferably set to 3.50, more preferably to 3.20.

In the variable magnification optical system of the present embodiment, the effect of the present embodiment can be ensured by setting the lower limit of conditional expression (17) to 2.00. To further ensure the effect of the present embodiment, the lower limit of conditional expression (17) is preferably set to 2.20 or 2.50, more preferably to 2.80.

In the variable magnification optical system of the present embodiment, the first negative lens group and each of the plurality of lens groups included in the rear lens group preferably consists of one or two lens components. The lens component refers to a single lens or a cemented lens.

A general variable magnification optical system having the lens group closest to the object side fixed cannot allow sufficient amount of movement of each lens group at varying magnification, making aberration correction difficult. The variation magnification optical system of the present embodiment including a number of lens groups can satisfactorily correct aberrations at varying magnification by changing the relative positions of the lens groups while the lens group closest to the object side is fixed. Further, the variable magnification optical system of the present embodiment can reduce the manufacturing error in the lens group by configuring each lens group with one or two lens components.

A small-sized variable magnification optical system of favorable imaging performance can be achieved by the above configurations.

An optical device of the present embodiment includes a variable magnification optical system configured as described above. This enables achieving an optical device of favorable optical performance.

A method for manufacturing the variable magnification optical system of the present embodiment includes configuring a variable magnification optical system including, in order from an object side, a first negative lens group having negative refractive power and a rear group having a plurality of lens groups, wherein, at varying magnification, the first negative lens group being fixed with respect to the image plane and the spacings between adjacent lens groups being changed, an aperture stop being disposed closer to the image plane side than the first negative lens group, and a second negative lens group having negative refractive power and disposed adjacent to the image plane side of the aperture stop among the plurality of lens groups included in the rear group, and the following conditional expression is satisfied:

0.00<fA/fCα<0.30 (1-1)

where
fA: the focal length of the first negative lens group
fCα: the focal length of the second negative lens group.

A manufacturing method of a variable magnification optical system of the present embodiment includes configuring a variable magnification optical system including, in order from the object side, a first negative lens group having negative refractive power and a rear group having a plurality of lens groups, wherein, at varying magnification, the first negative lens group being fixed to the image plane and the spacings between adjacent lens groups is changed, and a third negative lens group being disposed closest to the object side among one or more lens groups having negative refractive power and disposed closer to the image plane side than a first positive lens group having positive refractive power and disposed closest to the object side in the plurality of lens groups included in the rear group the lens group, and the following conditional expression is satisfied:

0.00<fA/fCβ<0.30 (1-2)

where
fA: the focal length of the first negative lens group
fCβ: the focal length of the third negative lens group.

A variable magnification optical system of favorable optical performance can be manufactured by such a method for manufacturing an optical system.

### NUMERICAL EXAMPLES

Examples of the present application will be described below with reference to the drawings.

### First Example

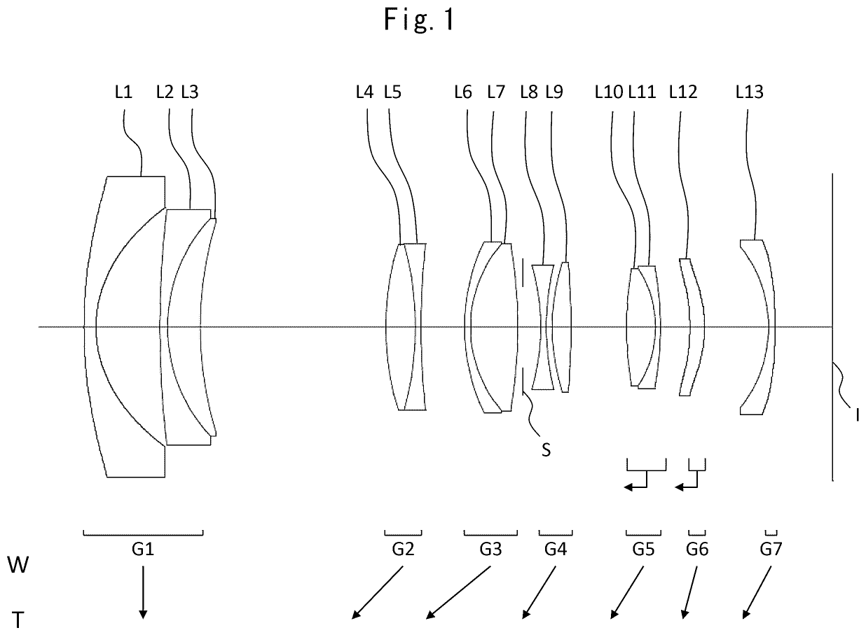

FIG. 1 is a cross-sectional view of a variable magnification optical system of a first example focusing on an object at infinity in the wide-angle end state.

The variable magnification optical system of the present example includes, in order from the object side, a first lens group G1 having negative refractive power, a second lens group G2 having positive refractive power, a third lens group G3 having positive refractive power, a fourth lens group G4 having negative refractive power, a fifth lens group G5 having positive refractive power, a sixth lens group G6 having positive refractive power, and a seventh lens group G7 having negative refractive power.

The first lens group G1 consists of, in order from the object side, a meniscus-shaped negative lens L1 convex on the object side, and a negative cemented lens composed of a meniscus-shaped negative lens L2 convex on the object side and a meniscus-shaped positive lens L3 convex on the object side.

The second lens group G2 consists of a positive cemented lens composed of a biconvex positive lens L4 and a biconcave negative lens L5.

The third lens group G3 consists of a positive cemented lens composed of a meniscus-shaped negative lens L6 convex on the object side and a biconvex positive lens L7.

The fourth lens group G4 consists of, in order from the object side, an aperture stop S, a biconcave negative lens L8, and a biconvex positive lens L9.

The fifth lens group G5 consists of a positive cemented lens composed of a biconvex positive lens L10 and a meniscus-shaped negative lens L11 concave on the object side.

The sixth lens group G6 consists of a meniscus-shaped positive lens L12 concave on the object side.

The seventh lens group G7 consists of a meniscus-shaped negative lens L13 concave on the object side.

An imaging device (not shown) constructed from CCD, CMOS, or the like is disposed on an image plane I.

In the variable magnification optical system of the present example, at varying magnification from the wide-angle end state to the telephoto end state, the first lens group G1 is fixed with respect to the image plane I, and the lens groups from the second lens group G2 to the seventh lens group G7 move respectively toward the object along the optical axis. In the variable magnification optical system of the present example, the distances between the adjacent lens groups from the first lens group G1 to the seventh lens group G7 change at varying magnification from the wide-angle end state to the telephoto end state.

The variable magnification optical system of the present example focuses by moving the fifth lens group G5 and the sixth lens group G6 respectively along the optical axis. When focus is shifted from infinity to a nearby object, the fifth lens group G5 and the sixth lens group G6 moves respectively from the image plane side to the object side.

In the variable magnification optical system of the present example, the first lens group G1 corresponds to the first negative lens group, and the lens groups from the second lens group G2 to the seventh lens group G7 correspond to a plurality of lens groups included in the rear group. The fourth lens group G4 corresponds to the second negative lens group and also corresponds to the third negative lens group. The positive lens L9 corresponds to the positive lens Cαp and also corresponds to the positive lens Cβp. The fifth lens group G5 corresponds to the first positive lens group, and the sixth lens group G6 corresponds to the second positive lens group. The seventh lens group G7 corresponds to the final negative lens group.

Table 1 below shows specifications of the variable magnification optical system of the present example.

In [General specifications], fW is the focal length of the whole system in the wide-angle end state; IT is the focal length of the whole system in the telephoto end state; FnoW is the f-number in the wide-angle end state; FnoT is the f-number in the telephoto end state; Y is the maximum image height; TL is the distance from the lens surface closest to the object side to the image plane; BfW is the back focal length in the wide-angle end state; BfT is the back focal length in the telephoto end state; 2ωw is the total field angle (degrees) in the wide-angle end state; 2ωt is the total field angle (degrees) in the telephoto end state.

In [Lens specifications], m denotes the numbers of optical surfaces counted from the object side, r the radii of curvature, d the surface-to-surface distances, nd the refractive indices at d-line (wavelength 587.6 nm), and νd the Abbe numbers based on d-line. The radius of curvature r=∞ means a plane. In [Lens specifications], the optical surfaces with “*” are aspherical surfaces.

In [Aspherical surface data], m denotes the optical surfaces corresponding to aspherical surface data, K the conic constants, and A4 to A12 the aspherical coefficients.

The aspherical surfaces are expressed by expression (a) below, where y denotes the height in a direction perpendicular to the optical axis, S(y) the distance along the optical axis from the tangent plane at the vertex of an aspherical surface to the aspherical surface at height y (a sag), r the radius of curvature of a reference sphere (paraxial radius of curvature), K the conic constant, and An the nth-order aspherical coefficient. In the examples, the second-order aspherical coefficient A2 is 0. “E-n” means “×10⁻ⁿ.”

S(y)=(y²/r)/{1+(1−K×y²/r²)^{1/2}}+A4×y⁴+A6×y⁶+A8×y⁸+A10×y¹⁰+A12×y¹² (a)

The unit of focal length fW and fT, radii of curvature r, and other lengths listed in Table 1 is “mm.” However, the values are not limited thereto because the optical performance of a proportionally enlarged or reduced optical system is the same as that of the original optical system.

The above reference symbols in Table 1 will also be used similarly in the tables of the other examples described below.

### (Table 1)

### [General Specifications]

fW 24.70
fT 67.87
FnoW 2.91
FnoT 2.91
Y 21.70
TL 154.49
BfW 11.88
BfT 31.36
2ωw 85.2
2ωt 34.2

### [Lens Specifications]

m r d nd νd
*1) 91.7979 2.500 1.69343 53.30
*2) 24.8133 13.186
3) 205.8871 1.600 1.59349 67.00
4) 33.0667 6.748 1.85451 25.15
5) 74.1233 D5
6) 58.2414 6.100 1.80610 40.97
7) −64.7564 1.200 1.85451 25.15
8) 174.3186 D8
9) 41.0895 1.200 1.85451 25.15
10) 26.2528 9.700 1.59319 67.90
11) −105.0945 D11
12) ∞ 3.829 (aperture stop)
13) −44.8793 1.100 1.80000 29.84
14) 54.7026 1.226
15) 43.8805 3.900 1.92286 20.88
16) −147.5133 D16
17) 68.4710 6.000 1.60300 65.44
18) −22.3383 1.000 1.80000 29.84
19) −66.2888 D19
*20) −41.6316 3.000 1.62291 58.30
*21) −27.7482 D21
22) −26.4884 1.300 1.51680 64.13
*23) −122.3734 D23

### [Aspherical Surface Data]

### m K A4 A6 A8 A10 A12

1) 2.0000 −2.524E−07 −1.113E−09 9.405E−13 −4.134E−16
2) 0.0000 4.973E−06 1.149E−09 −3.581E−12 1.109E−14 −1.057E−17
20) 1.1242 −1.201E−05 −7.544E−08 1.409E−09 −2.813E−12
21) 0.2808 7.022E−08 −8.237E−08 1.238E−09 −2.075E−12
23) 1.0000 −1.444E−05 2.967E−08 −1.982E−10 6.452E−13 −7.844E−16

### [Focal Length Data of Groups]

### Groups First Surfaces Focal Lengths

G1 1 −46.83
G2 6 117.69
G3 9 61.85
G4 12 −263.12
G5 17 83.70
G6 20 123.35
G7 22 −65.72

### [Variable Spacing Data]

### At Focusing on Infinity At Focusing Nearby (165 mm)

### Wide-Angle Midpoint Telephoto Wide-Angle Midpoint Telephoto

D5 38.300 5.352 1.552 38.300 5.352 1.552
D8 8.963 13.031 1.000 8.963 13.031 1.000
D11 1.001 14.827 23.778 1.001 14.827 23.778
D16 11.426 13.415 13.619 8.568 5.333 2.203
D19 6.100 14.918 15.683 6.672 16.534 16.254
D21 13.232 6.159 3.913 15.519 12.624 14.758
D23 11.876 23.199 31.365 11.876 23.199 31.365

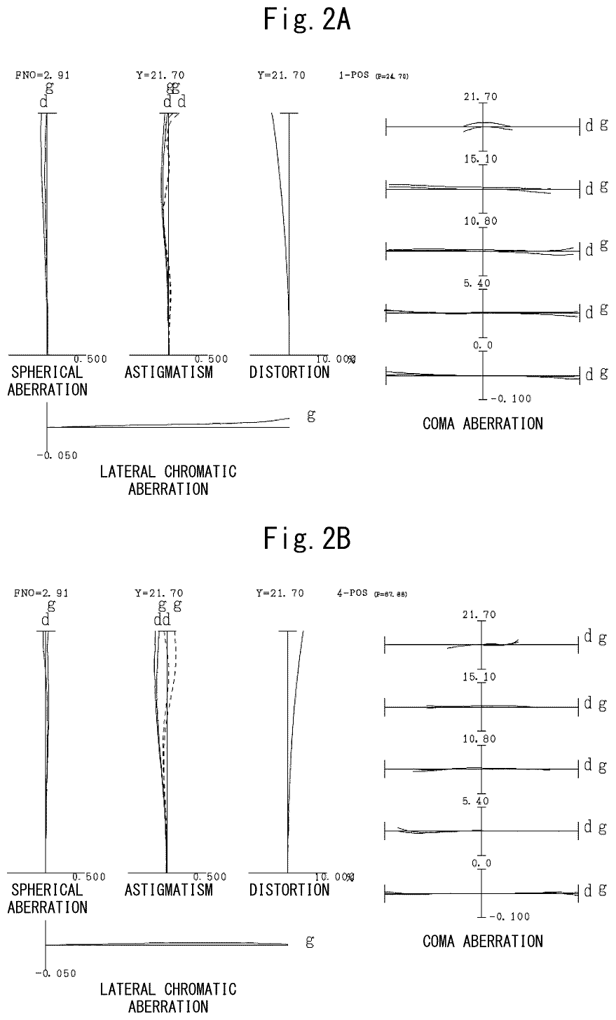

FIG. 2A shows aberrations of the variable magnification optical system of the first example focusing on an object at infinity in the wide-angle end state; FIG. 2B shows aberrations of the variable magnification optical system of the first example focusing on an object at infinity in the telephoto end state.

In the graphs of aberrations, FNO and Y denote f-number and image height, respectively. More specifically, the graph of spherical aberration shows the f-number corresponding to the maximum aperture; the graphs of astigmatism and distortion show the maximum of image height; the graphs of coma aberration show the values of image height. d and g denote d-line and g-line (wavelength 435.8 nm), respectively. In the graph of astigmatism, the solid lines and the broken lines show a sagittal plane and a meridional plane, respectively. The reference symbols in the graphs of aberrations of the present example will also be used in those of the other examples described below.

The graphs of aberrations suggest that the variable magnification optical system of the present example corrects aberrations appropriately and has high optical performance.

### Second Example

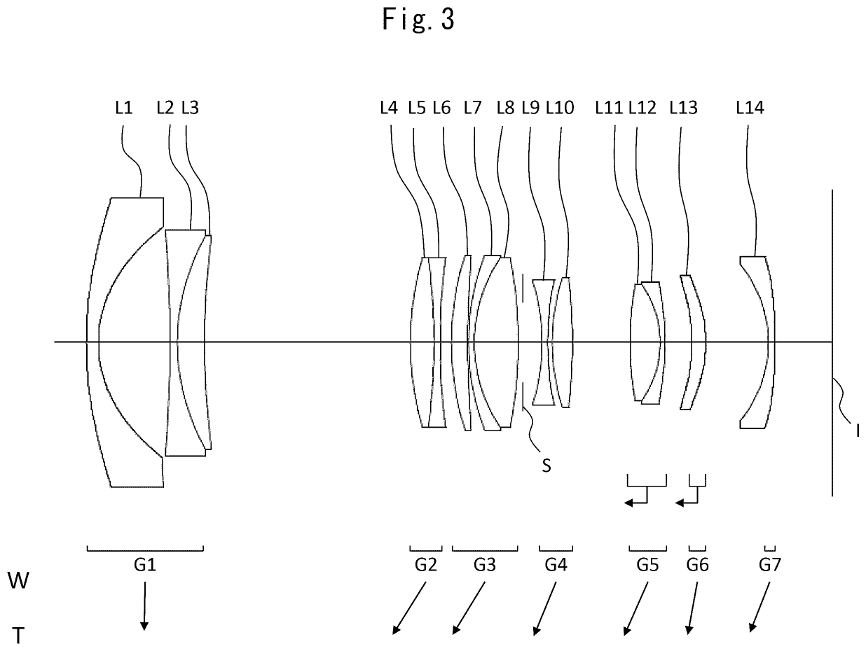

FIG. 3 is a cross-sectional view of a variable magnification optical system of a second example focusing on infinity in the wide-angle end state.

The variable magnification optical system of the present example includes, in order from the object side, a first lens group G1 having negative refractive power, a second lens group G2 having positive refractive power, a third lens group G3 having positive refractive power, a fourth lens group G4 having negative refractive power, a fifth lens group G5 having positive refractive power, a sixth lens group G6 having positive refractive power, and a seventh lens group G7 having negative refractive power.

The first lens group G1 consists of, in order from the object side, a meniscus-shaped negative lens L1 convex on the object side, and a negative cemented lens composed of a biconcave negative lens L2 and a meniscus-shaped positive lens L3 convex on the object side.

The second lens group G2 consists of a positive cemented lens composed of a biconvex positive lens L4 and a biconcave negative lens L5.

The third lens group G3 consists of, in order from the object side, a meniscus-shaped positive lens L6 convex on the object side, and a positive cemented lens composed of a meniscus-shaped negative lens L7 convex on the object side and a biconvex positive lens L8.

The fourth lens group G4 consists of, in order from the object side, an aperture stop S, a biconcave negative lens L9, and a biconvex positive lens L10.

The fifth lens group G5 consists of a positive cemented lens composed of a biconvex positive lens L11 and a meniscus-shaped negative lens L12 concave on the object side.

The sixth lens group G6 consists of a meniscus-shaped positive lens L13 concave on the object side.

The seventh lens group G7 consists of a meniscus-shaped negative lens L14 concave on the object side.

An imaging device (not shown) constructed from CCD, CMOS, or the like is disposed on an image plane I.

In the variable magnification optical system of the present example, at varying magnification from the wide-angle end state to the telephoto end state, the first lens group G1 is fixed with respect to the image plane I, and the lens groups from the second lens group G2 to the seventh lens group G7 move respectively toward the object along the optical axis. In the variable magnification optical system of the present example, the distances between the adjacent lens groups from the first lens group G1 to the seventh lens group G7 change at varying magnification from the wide-angle end state to the telephoto end state.

The variable magnification optical system of the present example focuses by moving the fifth lens group G5 and the sixth lens group G6 respectively along the optical axis. When focus is shifted from infinity to a nearby object, the fifth lens group G5 and the sixth lens group G6 moves respectively from the image plane side to the object side.

In the variable magnification optical system of the present example, the first lens group G1 corresponds to the first negative lens group, and the lens groups from the second lens group G2 to the seventh lens group G7 correspond to a plurality of lens groups included in the rear group. The fourth lens group G4 corresponds to the second negative lens group and also corresponds to the third negative lens group. The positive lens L10 corresponds to the positive lens Cαp and also corresponds to the positive lens Cβp. The fifth lens group G5 corresponds to the first positive lens group, and the sixth lens group G6 corresponds to the second positive lens group. The seventh lens group G7 corresponds to the final negative lens group.

Table 2 below shows specifications of the variable magnification optical system of the present example.

### (Table 2)

### [General Specifications]

fW 24.70
fT 67.87
FnoW 2.91
FnoT 2.91
Y 21.70
TL 154.46
BfW 11.85
BfT 29.50
2ωw 85.5
2ωt 34.0

### [Lens Specifications]

m r d nd νd
*1) 81.5606 2.500 1.69343 53.30
*2) 24.9268 14.774
3) −317.9158 1.600 1.59349 67.00
4) 44.8065 5.605 1.85451 25.15
5) 161.5239 D5
6) 60.9829 5.000 1.80610 40.97
7) −124.9111 1.200 1.84666 23.80
8) 132.8335 D8
9) 59.0944 3.400 1.59349 67.00
10) 235.9189 0.150
11) 51.3297 1.200 1.85451 25.15
12) 31.3382 9.100 1.49782 82.57
13) −92.8181 D13
14) ∞ 3.970 (aperture stop)
15) −41.6498 1.100 1.85883 30.00
16) 60.2574 0.970
17) 44.6327 4.200 1.92286 20.88
18) −111.0085 D18
19) 72.1996 6.200 1.59349 67.00
20) −21.0188 1.000 1.77047 29.74
21) −62.0569 D21
*22) −42.2359 2.900 1.62291 58.30
*23) −28.0725 D23
24) −25.2494 1.300 1.51680 64.13
*25) −170.9229 D25

### [Aspherical Surface Data]

### m K A4 A6 A8 A10 A12

1) 2.0000 −3.346E−10 −1.631E−09 8.861E−13 −3.347E−16
2) 0.0000 5.692E−06 1.259E−09 −3.304E−12 7.355E−15 −9.172E−18
22) 0.7938 −2.319E−05 −3.004E−08 1.183E−09 −2.355E−12
23) 0.2725 −9.524E−06 −4.572E−08 1.082E−09 −1.851E−12
25) 1.0000 −1.431E−05 2.423E−08 −1.539E−10 5.368E−13 −6.402E−16

### [Focal Length Data of Groups]

### Groups First Surfaces Focal Lengths

G1 1 −47.93

G2 6 146.66

G3 9 56.68

G4 14 −223.50

G5 19 82.73

G6 22 124.60

G7 24 −57.50

### [Variable Spacing Data]

### At Focusing on Infinity At Focusing Nearby (165 mm)

### Wide-Angle Midpoint Telephoto Wide-Angle Midpoint Telephoto

D5 42.598 5.259 1.238 42.598 5.259 1.238
D8 2.356 12.947 2.305 2.356 12.947 2.305
D13 1.000 13.547 22.400 1.000 13.547 22.400
D18 11.961 13.171 12.959 9.304 5.626 2.164
D21 5.559 15.041 16.040 5.825 16.172 16.256
D23 12.963 5.848 3.863 15.353 12.261 14.442
D25 11.855 22.479 29.495 11.855 22.479 29.495

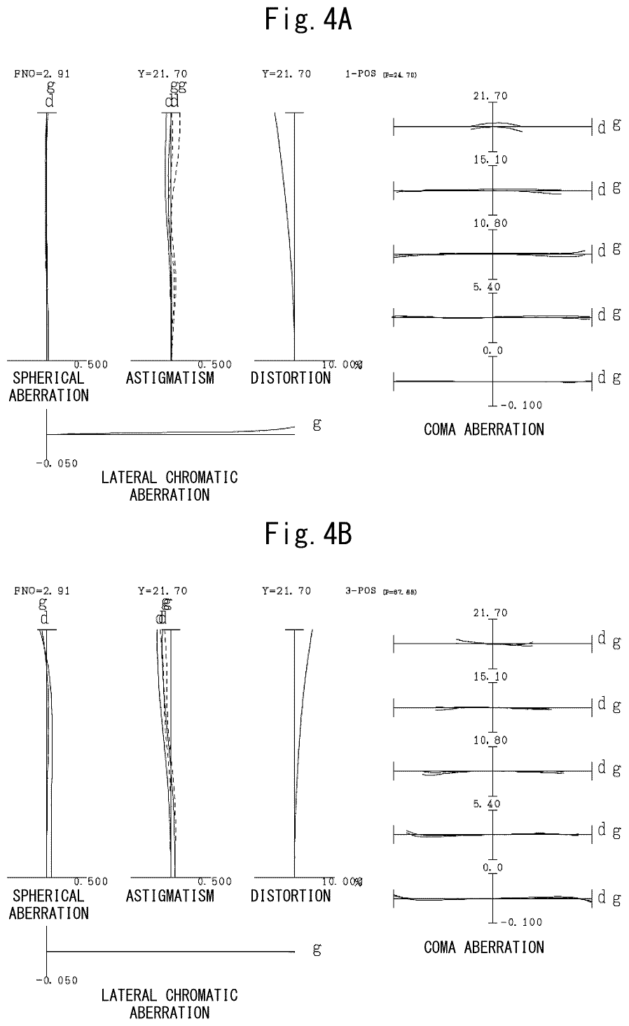

FIG. 4A shows aberrations of the variable magnification optical system of the second example focusing on an object at infinity in the wide-angle end state; FIG. 4B shows aberrations of the variable magnification optical system of the second example focusing on an object at infinity in the telephoto end state.

The graphs of aberrations suggest that the variable magnification optical system of the present example corrects aberrations appropriately and has high optical performance.

### Third Example

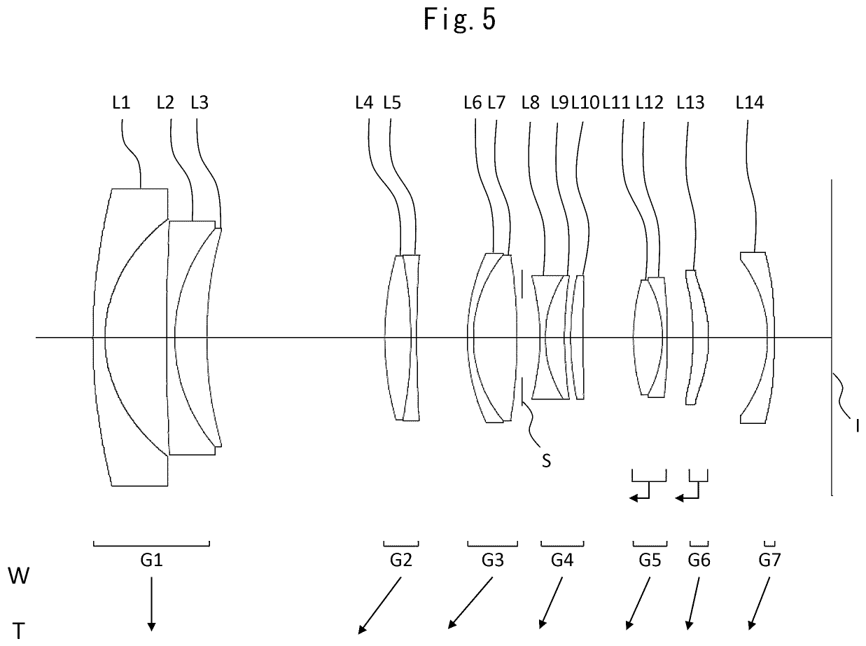

FIG. 5 is a cross-sectional view of a variable magnification optical system of a third example focusing on infinity in the wide-angle end state.

The variable magnification optical system of the present example includes, in order from the object side, a first lens group G1 having negative refractive power, a second lens group G2 having positive refractive power, a third lens group G3 having positive refractive power, a fourth lens group G4 having negative refractive power, a fifth lens group G5 having positive refractive power, a sixth lens group G6 having positive refractive power, and a seventh lens group G7 having negative refractive power.

The first lens group G1 consists of, in order from the object side, a meniscus-shaped negative lens L1 convex on the object side, and a meniscus-shaped negative lens L2 convex on the object side and a meniscus-shaped positive lens L3 convex on the object side.

The second lens group G2 consists of a positive cemented lens composed of a biconvex positive lens L4 and a biconcave negative lens L5.

The third lens group G3 consists of a positive cemented lens composed of a meniscus-shaped negative lens L6 convex on the object side and a biconvex positive lens L7.

The fourth lens group G4 consists of, in order from the object side, an aperture stop S, a negative cemented lens composed of a biconcave negative lens L8 and a meniscus positive lens L9 convex on the object side, and a meniscus positive lens L10 convex on the object side.

The fifth lens group G5 consists of a positive cemented lens composed of a biconvex positive lens L11 and a meniscus-shaped negative lens L12 concave on the object side.

The sixth lens group G6 consists of a meniscus-shaped positive lens L13 concave on the object side.

The seventh lens group G7 consists of a meniscus-shaped negative lens L14 concave on the object side.

An imaging device (not shown) constructed from CCD, CMOS, or the like is disposed on an image plane I.

In the variable magnification optical system of the present example, at varying magnification from the wide-angle end state to the telephoto end state, the first lens group G1 is fixed with respect to the image plane I, and the lens groups from the second lens group G2 to the seventh lens group G7 move respectively toward the object along the optical axis. In the variable magnification optical system of the present example, the distances between the adjacent lens groups from the first lens group G1 to the seventh lens group G7 change at varying magnification from the wide-angle end state to the telephoto end state.

The variable magnification optical system of the present example focuses by moving the fifth lens group G5 and the sixth lens group G6 respectively along the optical axis. When focus is shifted from infinity to a nearby object, the fifth lens group G5 and the sixth lens group G6 moves respectively from the image plane side to the object side.

In the variable magnification optical system of the present example, the first lens group G1 corresponds to the first negative lens group, and the lens groups from the second lens group G2 to the seventh lens group G7 correspond to a plurality of lens groups included in the rear group. The fourth lens group G4 corresponds to the second negative lens group and also corresponds to the third negative lens group. The positive lens L10 corresponds to the positive lens Cαp and also corresponds to the positive lens Cβp. The fifth lens group G5 corresponds to the first positive lens group, and the sixth lens group G6 corresponds to the second positive lens group. The seventh lens group G7 corresponds to the final negative lens group.

Table 3 below shows specifications of the variable magnification optical system of the present example.

### (Table 3)

### [General Specifications]

fW 24.70
fT 67.88
FnoW 2.91
FnoT 2.91
Y 21.70
TL 152.47
BfW 11.86
BfT 32.41
2ωw 86.1
2ωt 34.2

### [Lens Specifications]

m r d nd νd

*1) 113.0242 2.500 1.69343 53.30
*2) 27.0114 12.703
3) 484.2680 1.700 1.59349 67.00
4) 34.5393 6.595 1.85451 25.15
5) 82.6275 D5
6) 62.2043 5.400 1.83481 42.73
7) −86.8334 1.200 1.92119 23.96
8) 270.5523 D8
9) 42.2558 1.200 1.85451 25.15
10) 26.8537 9.000 1.59319 67.90
11) −114.3935 D11
12) ∞ 3.742 (aperture stop)
13) −50.4224 1.100 1.78880 28.43
14) 23.2314 4.000 2.00069 25.46
15) 86.5782 1.298
16) 65.9144 2.500 1.94594 17.98
17) 643.3273 D17
18) 43.5273 6.000 1.59319 67.90
19) −24.7099 1.000 1.80610 33.34
20) −122.9676 D20
*21) −64.4392 3.200 1.55332 71.68
*22) −29.8433 D22
23) −26.1013 1.400 1.48749 70.32
*24) −159.4137 D24

### [Aspherical Surface Data]

### m K A4 A6 A8 A10 A12

1) 2.0000 −5.184E−07 1.118E−11 4.006E−13 −3.987E−16 1.108E−19
2) 0.0000 3.862E−06 1.842E−09 −1.517E−12 6.440E−15 −4.655E−18
21) 0.5001 2.012E−05 1.035E−07 1.503E−09-2.536E−12
22) 0.0215 −3.912E−06 −1.133E−07 1.353E−09 −1.920E−12
24) 1.4275 −1.331E−05 1.498E−08 −5.411E−11 1.346E−13

### [Focal Length Data of Groups]

### Groups First Surfaces Focal Lengths

G1 1 −46.32
G2 6 108.45
G3 9 64.83
G4 12 −209.03
G5 18 85.81
G6 21 97.26
G7 23 −64.25

### [Variable Spacing Data]

### At Focusing on Infinity At Focusing Nearby (165 mm)

### Wide-Angle Midpoint Telephoto Wide-Angle Midpoint Telephoto

D5 36.730 4.893 1.543 1.543 36.730 4.893 1.543
D8 10.472 13.706 1.075 10.472 13.706 1.075
D11 1.000 16.141 24.566 1.000 16.141 24.566
D17 10.397 9.910 10.265 8.419 4.077 2.068
D20 5.307 13.425 14.354 4.912 12.842 12.714
D22 12.166 6.512 3.716 14.540 12.928 13.552
D24 11.857 23.342 32.414 11.857 23.342 32.414

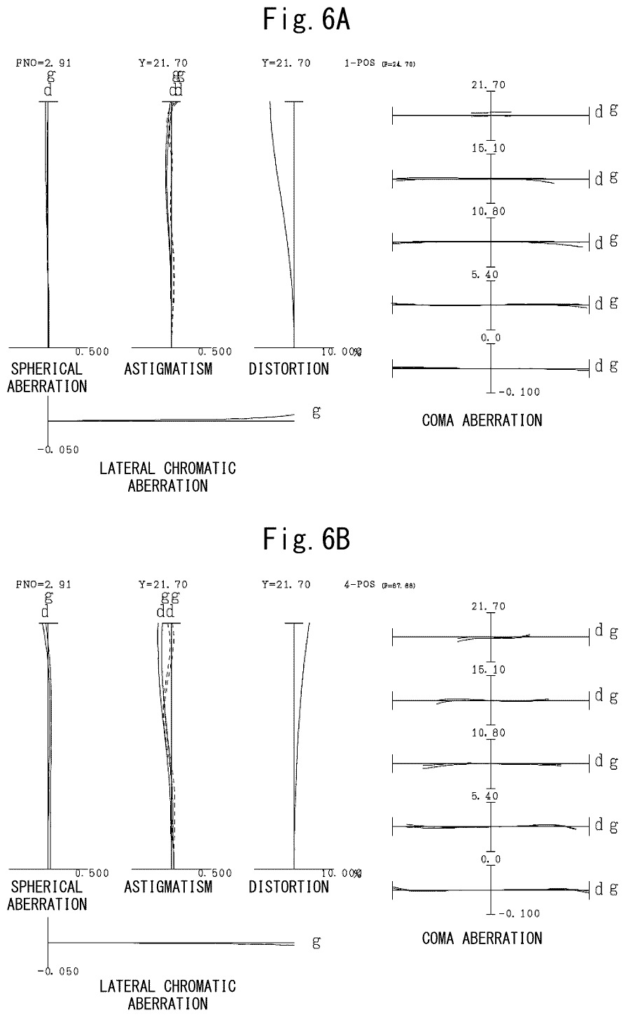

FIG. 6A shows aberrations of the variable magnification optical system of the third example focusing on an object at infinity in the wide-angle end state; FIG. 6B shows aberrations of the variable magnification optical system of the third example focusing on an object at infinity in the telephoto end state.

The graphs of aberrations suggest that the variable magnification optical system of the present example corrects aberrations appropriately and has high optical performance.

### Fourth Example

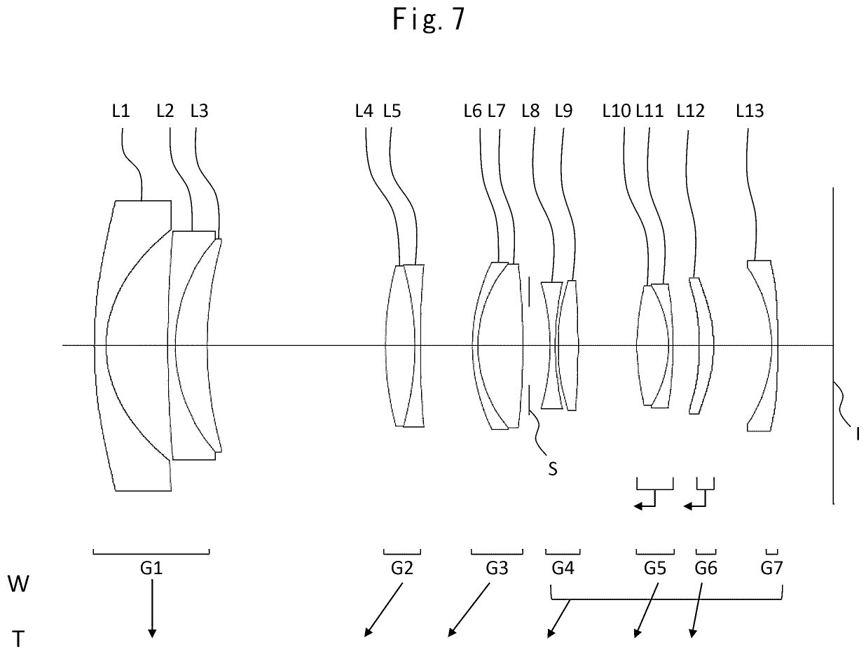

FIG. 7 is a cross-sectional view of a variable magnification optical system of a fourth example focusing on infinity in the wide-angle end state.

The variable magnification optical system of the present example includes, in order from the object side, a first lens group G1 having negative refractive power, a second lens group G2 having positive refractive power, a third lens group G3 having positive refractive power, a fourth lens group G4 having negative refractive power, a fifth lens group G5 having positive refractive power, a sixth lens group G6 having positive refractive power, and a seventh lens group G7 having negative refractive power.

The first lens group G1 consists of, in order from the object side, a meniscus-shaped negative lens L1 convex on the object side, and a meniscus-shaped negative lens L2 convex on the object side and a meniscus-shaped positive lens L3 convex on the object side.

The second lens group G2 consists of a positive cemented lens composed of a biconvex positive lens L4 and a biconcave negative lens L5.

The third lens group G3 consists of a positive cemented lens composed of a meniscus-shaped negative lens L6 convex on the object side and a biconvex positive lens L7.

The fourth lens group G4 consists of, in order from the object side, an aperture stop S, a biconcave negative lens L8, and a biconvex positive lens L9.

The fifth lens group G5 consists of a positive cemented lens composed of a biconvex positive lens L10 and a meniscus-shaped negative lens L11 concave on the object side.

The sixth lens group G6 consists of a meniscus-shaped positive lens L12 concave on the object side.

The seventh lens group G7 consists of a meniscus-shaped negative lens L13 concave on the object side.

An imaging device (not shown) constructed from CCD, CMOS, or the like is disposed on an image plane I.

In the variable magnification optical system of the present example, at varying magnification from the wide-angle end state to the telephoto end state, the first lens group G1 is fixed with respect to the image plane I, the second lens group G2, the third lens group G3, the fifth lens group G5, and the sixth lens group G6 move respectively toward the object along the optical axis, and the fourth lens group G4 and the seventh lens group G7 move together toward the object along the optical axis. In the variable magnification optical system of the present example, the distances between the adjacent lens groups from the first lens group G1 to the seventh lens group G7 change at varying magnification from the wide-angle end state to the telephoto end state.

The variable magnification optical system of the present example focuses by moving the fifth lens group G5 and the sixth lens group G6 respectively along the optical axis. When focus is shifted from infinity to a nearby object, the fifth lens group G5 and the sixth lens group G6 moves respectively from the image plane side to the object side.

In the variable magnification optical system of the present example, the first lens group G1 corresponds to the first negative lens group, and the lens groups from the second lens group G2 to the seventh lens group G7 correspond to a plurality of lens groups included in the rear group. The fourth lens group G4 corresponds to the second negative lens group and also corresponds to the third negative lens group. The positive lens L9 corresponds to the positive lens Cαp and also corresponds to the positive lens Cβp. The fifth lens group G5 corresponds to the first positive lens group, and the sixth lens group G6 corresponds to the second positive lens group. The seventh lens group G7 corresponds to the final negative lens group.

Table 4 below shows specifications of the variable magnification optical system of the present example.

### (Table 4)

### [General Specifications]

fW 24.70
fT 67.88
FnoW 2.91
FnoT 2.91
Y 21.70
TL 157.47
BfW 11.85
BfT 35.24
2ωw 83.9
2ωt 34.2

### [Lens Specifications]

m r d nd νd
*1) 91.5236 2.500 1.69343 53.30
*2) 24.7992 13.170
3) 272.4225 1.600 1.59349 67.00
4) 34.4978 6.787 1.85451 25.15
5) 81.8187 D5
6) 65.3714 6.300 1.80953 43.30
7) −62.1136 1.200 1.85451 25.15
8) 214.2370 D8
9) 39.9742 1.200 1.85451 25.15
10) 26.9616 9.600 1.59319 67.90
11) −152.7840 D11
12) ∞ 4.445 (aperture stop)
13) −47.6472 1.100 1.80518 25.45
14) 60.2175 0.562
15) 45.0104 4.300 1.94594 17.98
16) −182.7153 D16
17) 53.9882 6.700 1.59349 67.00
18) −24.2233 1.000 1.79504 28.69
19) −78.7257 D19
*20) −51.0548 3.000 1.62291 58.30
*21) −31.0935 D21
22) −29.7108 1.300 1.51680 64.13
*23) −268.1881 D23

### [Aspherical Surface Data]

### m K A4 A6 A8 A10 A12

1) 2.0000 −7.064E−07 −9.632E−10 8.654E−13 −3.573E−16
2) 0.0000 4.038E−06 6.142E−10 3.446E−12 7.969E−15 −6.976E−18
20) 1.5303 −1.734E−05 −8.244E−08 1.216E−09 −2.555E−12
21) 0.6700 −1.359E−06 −9.643E−08 1.166E−09 −2.246E−12
23) 1.0000 −1.284E−05 3.566E−08 −2.146E−10 6.465E−13 −6.731E−16

### [Focal Length Data of Groups]

### Groups First Surfaces Focal Lengths

G1 1 −46.96
G2 6 126.51
G3 9 65.06
G4 12 −294.44
G5 17 78.91
G6 20 120.71
G7 22 −64.77

### [Variable Spacing Data]

### At Focusing on Infinity At Focusing Nearby (165 mm)

### Wide-Angle Midpoint Telephoto Wide-Angle Midpoint Telephoto

D5 37.931 6.076 1.500 37.931 6.076 1.500
D8 11.032 3.526 1.555 11.032 13.526 1.555
D11 1.346 15.093 23.854 1.346 15.093 23.854
D16 12.554 12.982 12.149 9.602 5.973 1.843
D19 5.598 13.032 15.628 6.484 13.733 15.628
D21 12.389 4.536 2.777 14.455 10.844 13.083
D23 11.855 27.469 35.242 11.855 27.469 35.242

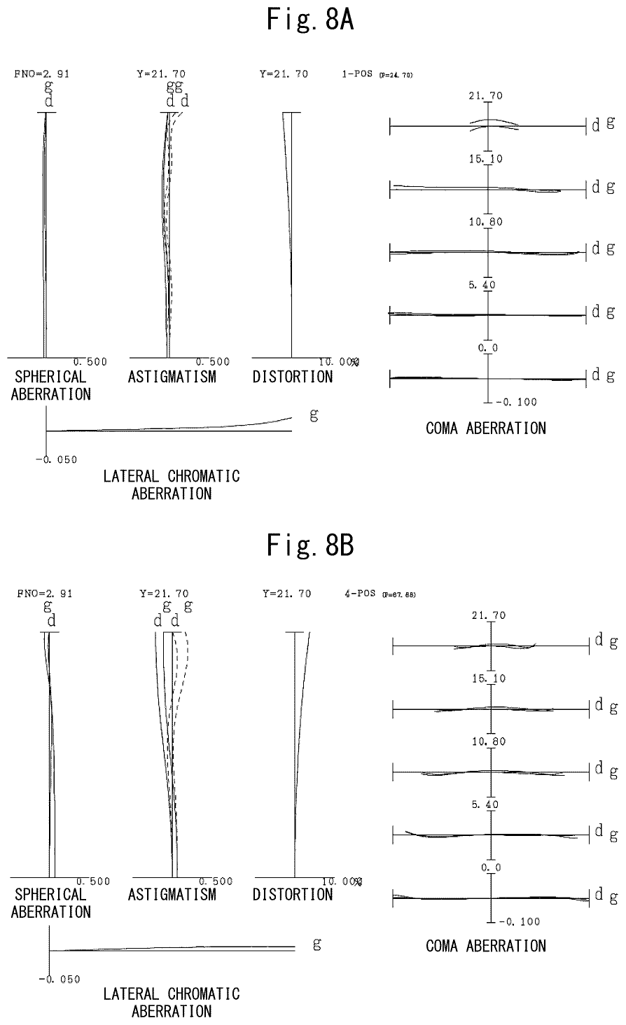

FIG. 8A shows aberrations of the variable magnification optical system of the fourth example focusing on an object at infinity in the wide-angle end state; FIG. 8B shows aberrations of the variable magnification optical system of the fourth example focusing on an object at infinity in the telephoto end state.

The graphs of aberrations suggest that the variable magnification optical system of the present example corrects aberrations appropriately and has high optical performance.

### Fifth Example

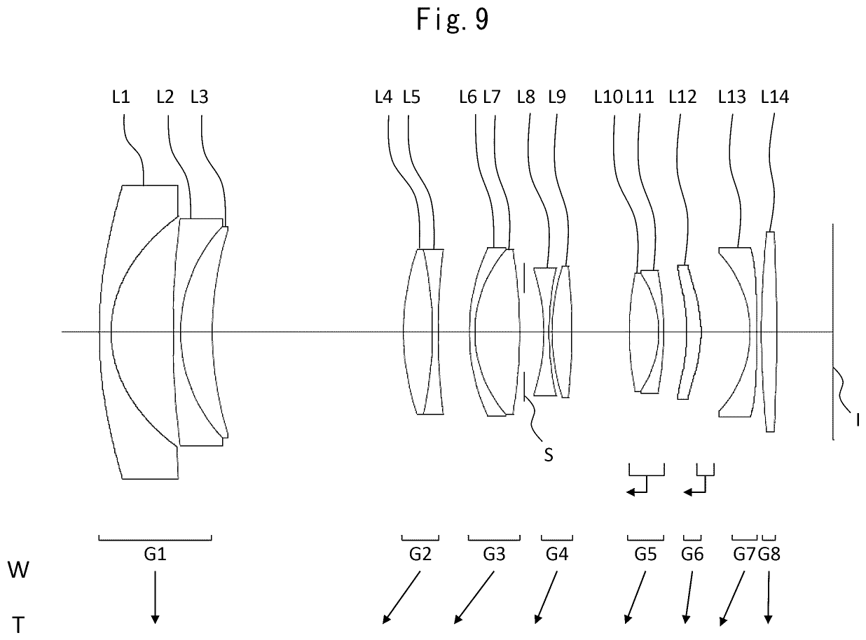

FIG. 9 is a cross-sectional view of a variable magnification optical system of a fifth example focusing on infinity in the wide-angle end state.

The variable magnification optical system of the present example includes, in order from the object side, a first lens group G1 having negative refractive power, a second lens group G2 having positive refractive power, a third lens group G3 having positive refractive power, a fourth lens group G4 having negative refractive power, a fifth lens group G5 having positive refractive power, a sixth lens group G6 having positive refractive power, a seventh lens group G7 having negative refractive power, and an eighth lens group G8 having positive refractive power.

The first lens group G1 consists of, in order from the object side, a meniscus-shaped negative lens L1 convex on the object side, and a meniscus-shaped negative lens L2 convex on the object side and a meniscus-shaped positive lens L3 convex on the object side.

The second lens group G2 consists of a positive cemented lens composed of a biconvex positive lens L4 and a biconcave negative lens L5.

The third lens group G3 consists of a positive cemented lens composed of a meniscus-shaped negative lens L6 convex on the object side and a biconvex positive lens L7.

The fourth lens group G4 consists of, in order from the object side, an aperture stop S, a biconcave negative lens L8, and a biconvex positive lens L9.

The fifth lens group G5 consists of a positive cemented lens composed of a biconvex positive lens L10 and a meniscus-shaped negative lens L11 concave on the object side.

The sixth lens group G6 consists of a meniscus-shaped positive lens L12 concave on the object side.

The seventh lens group G7 consists of a meniscus-shaped negative lens L13 concave on the object side.

The eighth lens group G8 consists of a biconvex positive lens L14.

An imaging device (not shown) constructed from CCD, CMOS, or the like is disposed on an image plane I.

In the variable magnification optical system of the present example, at varying magnification from the wide-angle end state to the telephoto end state, the first lens group G1 and the eighth lens group G8 are fixed with respect to the image plane I, and the lens groups from the second lens group G2 to the seventh lens group G7 move respectively toward the object along the optical axis. In the variable magnification optical system of the present example, the distances between the adjacent lens groups from the first lens group G1 to the eighth lens group G8 change at varying magnification from the wide-angle end state to the telephoto end state.

The variable magnification optical system of the present example focuses by moving the fifth lens group G5 and the sixth lens group G6 respectively along the optical axis. When focus is shifted from infinity to a nearby object, the fifth lens group G5 and the sixth lens group G6 moves respectively from the image plane side to the object side.

In the variable magnification optical system of the present example, the first lens group G1 corresponds to the first negative lens group, and the lens groups from the second lens group G2 to the eighth lens group G8 correspond to a plurality of lens groups included in the rear group. The fourth lens group G4 corresponds to the second negative lens group and also corresponds to the third negative lens group. The positive lens L9 corresponds to the positive lens Cαp and also corresponds to the positive lens Cβp. The fifth lens group G5 corresponds to the first positive lens group, and the sixth lens group G6 corresponds to the second positive lens group. The seventh lens group G7 corresponds to the final negative lens group.

Table 5 below shows specifications of the variable magnification optical system of the present example.

### (Table 5)

### [General Specifications]

fW 24.70
fT 67.88
FnoW 2.91
FnoT 2.91
Y 21.70
TL 154.47
BfW 11.85
BfT 11.85
2ωw 85.1
2ωt 34.0

### [Lens Specifications]

m r d nd νd
*1) 91.5000 2.500 1.69343 53.30
*2) 24.5646 13.019
3) 183.6981 1.600 1.59349 67.00
4) 32.4996 6.670 1.85451 25.15
5) 71.5000 D5
6) 53.2857 6.100 1.80610 40.97
7)-78.6421 1.200 1.85451 25.15
8) 140.8107 D8
9) 42.3911 1.200 1.85451 25.15
10) 26.3324 9.400 1.59319 67.90
11) −106.2952 D11
12) ∞ 4.101 (aperture stop)
13) −41.8719 1.100 1.79504 28.69
14) 62.3648 0.640
15) 45.3108 4.200 1.92286 20.88
16) −117.3113 D16
17) 63.3487 6.200 1.59319 67.90
18) −21.9837 1.000 1.76553 30.50
19) −71.8943 D19
*20) −43.9305 3.000 1.62291 58.30
*21) −29.4781 D21
22) −24.4507 1.400 1.51680 64.13
*23) −978.7313 D23
24) 205.4054 3.181 1.92676 34.23
25) −400.0000 D25

### [Aspherical Surface Data]

### m K A4 A6 A8 A10 A12

1) 2.0000 −1.719E−07 −1.293E−09 1.165E−12 −4.475E−16
2) 0.0000 5.189E−06 1.047E−09 −2.376E−12 7.539E−15 −5.920E−18
20) 1.1441 −1.265E−05 −3.909E−08 1.338E−09 −2.806E−12
21) 0.2737 −3.039E−08 −5.685E−08 1.204E−09 −2.026E−12
23) 1.0000 −1.428E−05 3.233E−08 −1.780E−10 5.474E−13 −6.724E−16

### [Focal Length Data of Groups]

### Groups First Surfaces Focal Lengths

G1 1 −46.46
G2 6 113.09
G3 9 64.39
G4 12 −390.82
G5 17 82.92
G6 20 133.23
G7 22 −48.55
G8 24 146.81

### [Variable Spacing Data]

### At Focusing on Infinity At Focusing Nearby (165 mm)

### Wide-Angle Midpoint Telephoto Wide-Angle Midpoint Telephoto

D5 40.263 6.002 2.200 40.263 6.002 2.200
D8 6.557 12.592 1.020 6.557 12.592 1.020
D11 1.000 13.988 21.801 1.000 13.988 21.801
D16 12.062 12.883 12.405 9.121 5.017 1.908
D19 4.863 14.997 15.553 5.746 16.570 15.553
D2 10.357 5.455 4.360 12.416 11.748 14.857
D23 1.000 10.190 18.772 1.000 10.190 18.772
D25 11.855 11.855 11.857 11.855 11.855 11.857

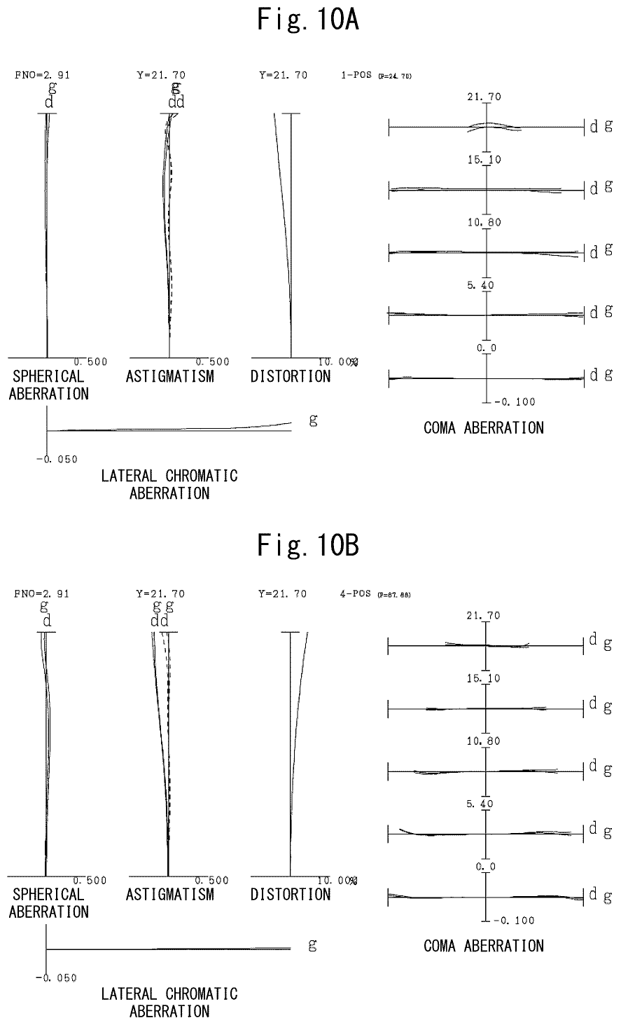

FIG. 10A shows aberrations of the variable magnification optical system of the fifth example focusing on an object at infinity in the wide-angle end state; FIG. 10B shows aberrations of the variable magnification optical system of the fifth example focusing on an object at infinity in the telephoto end state.

The graphs of aberrations suggest that the variable magnification optical system of the present example corrects aberrations appropriately and has high optical performance.

### Sixth Example

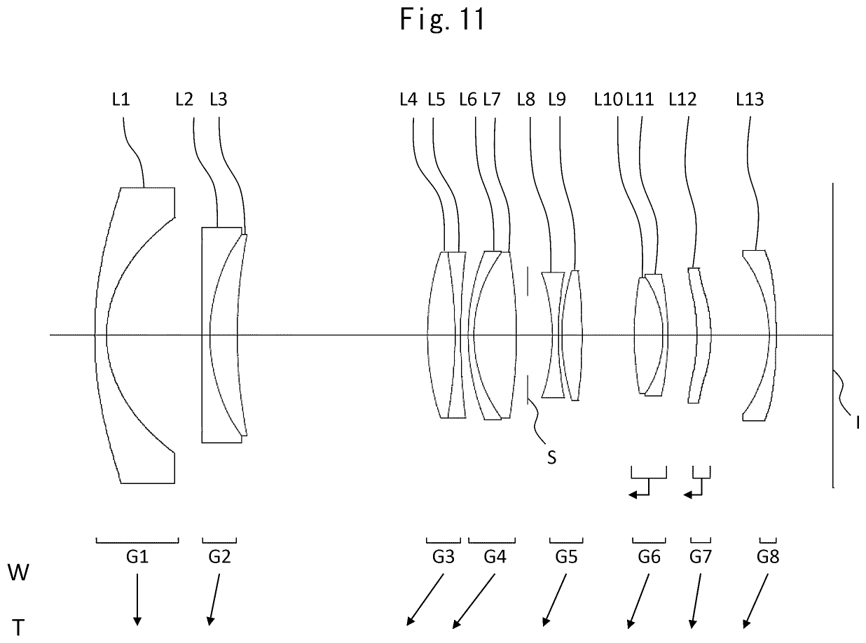

FIG. 11 is a cross-sectional view of a variable magnification optical system of a sixth example focusing on infinity in the wide-angle end state.

The variable magnification optical system of this example includes, in order from the object side, a first lens group G1 having negative refractive power, a second lens group G2 having negative refractive power, a third lens group G3 having positive refractive power, a fourth lens group G4 having positive refractive power, a fifth lens group G5 having negative refractive power, a sixth lens group G6 having positive refractive power, a seventh lens group G7 having positive refractive power, and an eighth lens group G8 having negative refractive power.

The first lens group G1 consists of a meniscus-shaped negative lens L1 convex on the object side.

The second lens group G2 consists of a meniscus negative lens L2 convex on the object side and a meniscus positive lens L3 convex on the object side.

The third lens group G3 consists of a positive cemented lens composed of a biconvex positive lens L4 and a biconcave negative lens L5.

The fourth lens group G4 consists of a positive cemented lens composed of a meniscus-shaped negative lens L6 convex on the object side and a biconvex positive lens L7.

The fifth lens group G5 consists of, in order from the object side, an aperture stop S, a biconcave negative lens L8, and a biconvex positive lens L9.

The sixth lens group G6 consists of a positive cemented lens composed of a biconvex positive lens L10 and a meniscus-shaped negative lens L11 concave on the object side.

The seventh lens group G7 consists of a meniscus-shaped positive lens L12 concave on the object side.

The eighth lens group G8 consists of a meniscus-shaped negative lens L13 concave on the object side.

An imaging device (not shown) constructed from CCD, CMOS, or the like is disposed on an image plane I.

In the variable magnification optical system of the present example, at varying magnification from the wide-angle end state to the telephoto end state, the first lens group G1 is fixed with respect to the image plane I, and the lens groups from the second lens group G2 to the eighth lens group G8 move respectively toward the object along the optical axis. In the variable magnification optical system of the present example, the distances between the adjacent lens groups from the first lens group G1 to the eighth lens group G8 change at varying magnification from the wide-angle end state to the telephoto end state.

The variable magnification optical system of the present example focuses by moving the sixth lens group G6 and the seventh lens group G7 respectively along the optical axis. When focus is shifted from infinity to a nearby object, the sixth lens group G6 and the seventh lens group G7 moves respectively from the image plane side to the object side.

In the variable magnification optical system of the present example, the first lens group G1 corresponds to the first negative lens group, and the lens groups from the second lens group G2 to the eighth lens group G8 correspond to a plurality of lens groups included in the rear group. The fifth lens group G5 corresponds to the second negative lens group and also corresponds to the third negative lens group. The positive lens L9 corresponds to the positive lens Cαp and also corresponds to the positive lens Cβp. The sixth lens group G6 corresponds to the first positive lens group, and the seventh lens group G7 corresponds to the second positive lens group. The eighth lens group G8 corresponds to the final negative lens group.

Table 6 below shows specifications of the variable magnification optical system of the present example.

### (Table 6)

### [General Specifications]

fW 24.70
fT 67.88
FnoW 2.91
FnoT 2.91
Y 21.70
TL 154.45
BfW 11.88
BfT 31.28
2ωw 85.2
2ωt 34.0

### [Lens Specifications]

m r d nd νd
*1) 79.0301 2.500 1.69343 53.30
*2) 24.9663 D2
3) 1803.0171 1.700 1.59349 67.00
4) 36.8431 5.739 1.85000 27.03
5) 107.4020 D5
6) 55.6485 5.800 1.78590 44.17
7) −98.4782 1.200 1.85451 25.15
8) 152.1147 D8
9) 46.6606 1.200 1.85451 25.15
10) 28.8553 8.900 1.59319 67.90
11) −103.6650 D11
12) ∞ 5.308 (aperture stop)
13) −38.4424 1.200 1.78880 28.43
14) 67.4561 0.773
15) 46.4815 4.200 1.92286 20.88
16) −110.3985 D16
17) 67.2607 6.000 1.59349 67.00
18) −21.7515 1.000 1.80000 29.84
19) −60.5113 D19
*20) −42.2019 3.000 1.62291 58.30
*21) −27.7951 D21
22) −27.5846 1.400 1.59245 66.92
*23) −144.3842 D23

### [Aspherical Surface Data]

### m K A4 A6 A8 A10 A12

1) 2.0000 −3.328E−07 −1.479E−09 1.133E−12 −4.851E−16
2) 0.0000 5.275E−06 1.334E−09 −4.600E−12 1.272E−14 −1.170E−17
20) 0.5232 −1.349E−05 9.846E−09 1.320E−09-3.179E−12
21) 0.0250 1.174E−06 −2.305E−08 1.314E−09 −2.594E−12
23) 1.0000 −1.440E−05 2.964E−08 −2.052E−10 6.926E−13 −8.815E−16

### [Focal Length Data of Groups]

### Groups First Surfaces Focal Lengths

G1 1 −53.65
G2 3 −2254.79
G3 6 122.75
G4 9 67.94
G5 12 −350.73
G6 17 80.46
G7 20 121.04
G8 22 −57.81

### [Variable Spacing Data]

### At Focusing on Infinity At Focusing Nearby (165 mm)

### Wide-Angle Midpoint Telephoto Wide-Angle Midpoint Telephoto

D2 19.895 15.198 14.660 19.895 15.198 14.660
D5 39.777 6.185 1.659 39.777 6.185 1.659
D8 1.536 12.076 1.008 1.536 12.076 1.008
D11 2.253 15.066 23.847 2.253 15.066 23.847
D16 10.961 12.706 13.075 8.112 4.766 1.914
D19 6.050 15.108 15.138 6.904 17.490 17.371
D21 12.179 5.841 3.873 14.173 11.399 12.802
D23 11.884 22.355 31.275 11.884 22.355 31.275

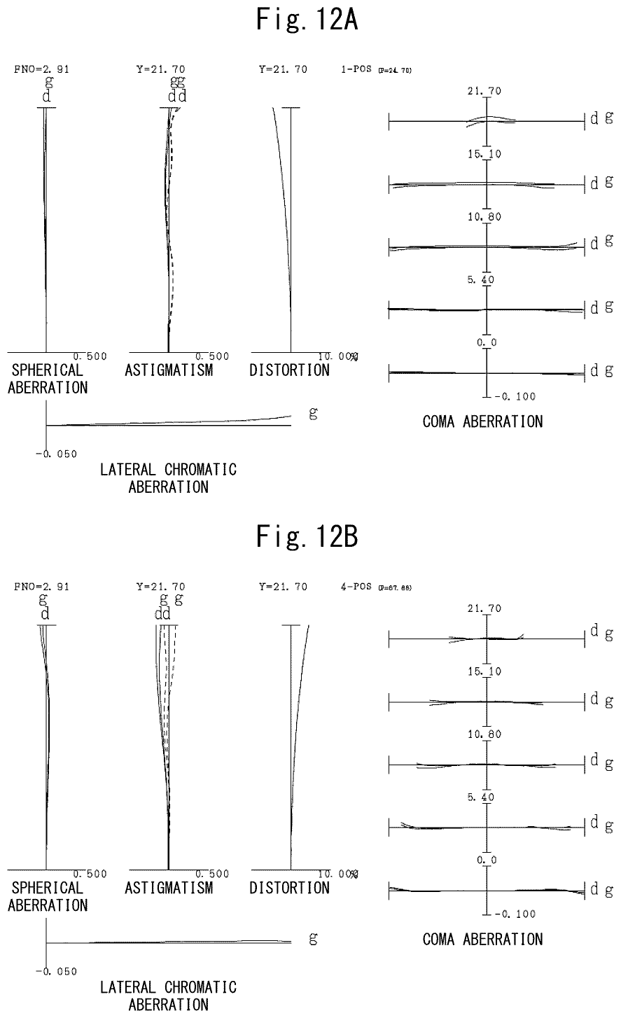

FIG. 12A shows aberrations of the variable magnification optical system of the sixth example focusing on an object at infinity in the wide-angle end state; FIG. 12B shows aberrations of the variable magnification optical system of the sixth example focusing on an object at infinity in the telephoto end state.

The graphs of aberrations suggest that the variable magnification optical system of the present example corrects aberrations appropriately and has high optical performance.

A variable magnification optical system of favorable optical performance can be achieved according to the above examples.

Conditional expression correspondence values of the respective examples are shown below.

Fw is the focal length of the variable magnification optical system at wide-angle end, and BFw is back focal length of the variable magnification optical system at wide-angle end. TLw is the distance on the optical axis from a lens surface closest to the object side to the image plane in the wide-angle end state; STLw is the distance on the optical axis from the aperture stop to the image plane in the wide-angle end state. Fnot is the f-number of the variable magnification optical system in the telephoto end state; 2ωw is the total field angle of the variable magnification optical system in the wide-angle end state; 2ωt is the total field angle of the variable magnification optical system in the telephoto end state.

fA is the focal length of the first negative lens group; fARw is the combined focal length of the rear group in the wide-angle end state. fB1 is the focal length of the first positive lens group; fB2 is the focal length of the second positive lens group. fCα is the focal length of the second negative lens group; fCβ is the focal length of the third negative lens group. fF1 is the focal length of a lens group on the object side of two lens groups having positive refractive power and moving at focusing; fF2 is the focal length of a lens group on the image plane side of the two lens groups. fE is the focal length of the final negative lens group.

PgFCαp is the partial dispersion ratio of the positive lens Cαp; νdCαp is the Abbe number based on d-line of the positive lens Cαp. PgFCβp is the partial dispersion ratio of the positive lens Cβp; νdCβp is the Abbe number based on d-line of the positive lens Cβp. The partial dispersion ratio PgFX of the lens X is defined by (ngX−nFX)/(nFX−nCX), where ngX, nFX, and nCX denote the refractive indices of the positive lens X at g-line, F-line, and C-line, respectively.

L1R1 is the radius of curvature of the object-side lens surface of the lens disposed closest to the object side; L1R2 is the radius of curvature of the image-plane-side lens surface the lens disposed closest to the object side. LLR1 is the radius of curvature of the object-side lens surface of the lens disposed closest to the image plane; LLR2 is the radius of curvature of the image-plane-side lens surface of the lens disposed closest to the image plane.

MVGCα is the amount of movement of the second negative lens group focusing on infinity at varying magnification from the wide-angle end to the telephoto end; MVGCβ is the amount of movement of the third negative lens group focusing on infinity at varying magnification from the wide-angle end to the telephoto end. MVF1w is the amount of movement of a lens group on the object side of two lens groups moving at focusing among the plurality of lens groups included in a rear group at focusing from infinity to nearby in the wide-angle end state; MVF2w is the movement amount of a lens group on the image plane side the two lens groups at focusing from infinity to nearby in the wide-angle end state. MVGO is the amount of movement of the lens group disposed adjacent to the object side of the final negative lens group at varying magnification from the wide-angle end state to the telephoto end state at focusing on infinity; MVGE is the amount of movement of the final negative lens group at varying magnification from the wide-angle end to the telephoto end at focusing on infinity.

### [Values for Conditional Expressions]

### Conditional Expressions First Second Third Fourth Fifth Sixth

(1-1) fA/fCα 0.178 0.214 0.222 0.159 0.119 0.153
(1-2) fA/fCβ 0.178 0.214 0.222 0.159 0.119 0.153
(2-1) MVGCα/MVGE 1.126 1.135 1.023 1.001 1.283 1.149
(2-2) MVGCβ/MVGE 1.126 1.135 1.023 1.001 1.283 1.149
(3-1) PgFCαp−0.64435+0.00168*νdCαp
   0.030 0.030 0.040 0.040 0.030 0.030
(3-2) PgFCβp−0.64435+0.00168*νdCβp
   0.030 0.030 0.040 0.040 0.030 0.030
(4-1) fw/(−fCα) 0.094 0.111 0.118 0.084 0.063 0.070
(4-2) fw/(−fCβ) 0.094 0.111 0.118 0.084 0.063 0.070
(5) STLw/TLw 0.414 0.414 0.420 0.412 0.421 0.414
(6) fB1/fB2 1.903 2.588 1.673 1.945 1.756 1.807
(7) −fA/fARw 1.218 1.275 1.218 1.198 1.178 1.391
(8) fA/fE 0.713 0.833 0.721 0.725 0.957 0.928
(9) fF1/fF2 0.679 0.664 0.882 0.654 0.622 0.665
(10) MVF1w/MVF2w 1.249 1.111 0.833 1.429 1.429 1.429
(11) MVGO/MVGE 0.522 0.484 0.589 0.589 0.663 0.572
(12) Bfw/fw 0.481 0.480 0.480 0.480 0.480 0.481
(13) (L1R2+L1R1)/(L1R2−L1R1)
   1.741-1.880-1.628-1.743-1.734-1.924
(14) (LLR2+LLR1)/(LLR2−LLR1)
   1.553 1.347 1.392 1.249 1.051 1.472
(15) 2ωw 85.200 85.500 86.100 83.900 85.100 85.200
(16) 2ωt 34.200 34.000 34.200 34.200 34.000 34.000
(17) Fnot 2.910 2.910 2.910 2.910 2.910 2.910

The above examples are specific examples of the present invention, and the present invention is not limited thereto. The following features can be appropriately employed unless the optical performance of the variable magnification optical system of the embodiment of the present application is compromised.

In the variable magnification optical system of the present embodiment, the third negative lens group need not necessarily include an aperture stop. The position of the aperture stop in the variable magnification optical system of the present embodiment is not limited to any of the positions of the aperture stop S in the variable magnification optical systems of the above examples.

The variable magnification optical system of the present embodiment may include an optical member, such as a filter, between the image plane and the lens surface closest to the image plane.

The variable magnification optical system of the present embodiment may include a vibration reduction lens group configured to make a movement including a component in a direction perpendicular to the optical axis to correct an image blur caused by shaky hands. The vibration reduction lens group may be a lens group or a lens subgroup consisting of one or more lens components included in a lens group.

In the variable magnification optical system of the present embodiment, the lens surface may be spherical, plane, or aspherical surfaces. Spherical or flat surface are preferable because they facilitate lens machining, assembling, and adjustment and because depiction performance does not decrease much when the image plane is shifted.

An aspherical surface may be formed by grinding glass or a glass molding with a mold having an aspherical shape, or formed on the surface of a resin bonded on a glass surface. In the variable magnification optical system of the present embodiment, lens surfaces may be diffractive surfaces, and lenses may be graded index lenses (GRIN lenses) or plastic lenses.

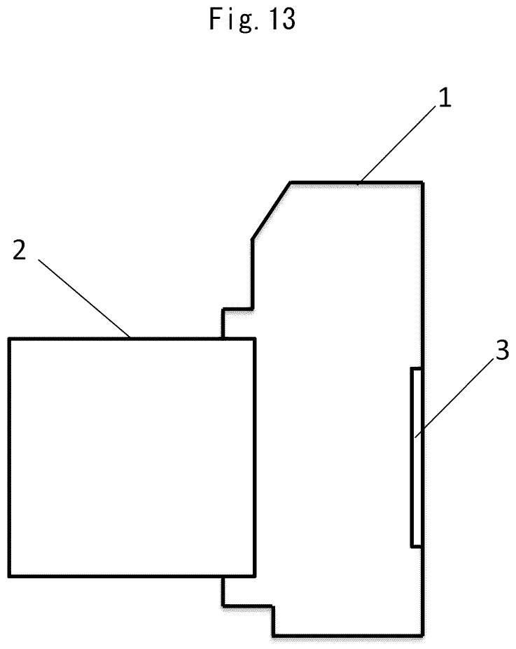

Next, a camera including the variable magnification optical system of the present embodiment will be described with reference to FIG. 13.

FIG. 13 schematically shows a camera including the variable magnification optical system of the present embodiment.

The camera 1 is a “mirror-less” camera of an interchangeable lens type including the optical system of the first example as an imaging lens 2.

In the camera 1, light from an object (subject) (not shown) is condensed by the imaging lens 2 and reaches an imaging device 3. The imaging device 3 converts the light from the subject to image data. When a release button (not shown) is pressed by a user who takes a photograph, the image data is stored in a memory (not shown). In this way, the user can take a picture of the subject with the camera 1.

The variable magnification optical system of the first example included in the camera 1 as the imaging lens 2 is a variable magnification optical system of favorable optical performance. Thus, the camera 1 can achieve favorable optical performance. A camera configured by including any of the variable magnification optical system of the second to sixth examples as the imaging lens 2 can have the same effect as the camera 1.

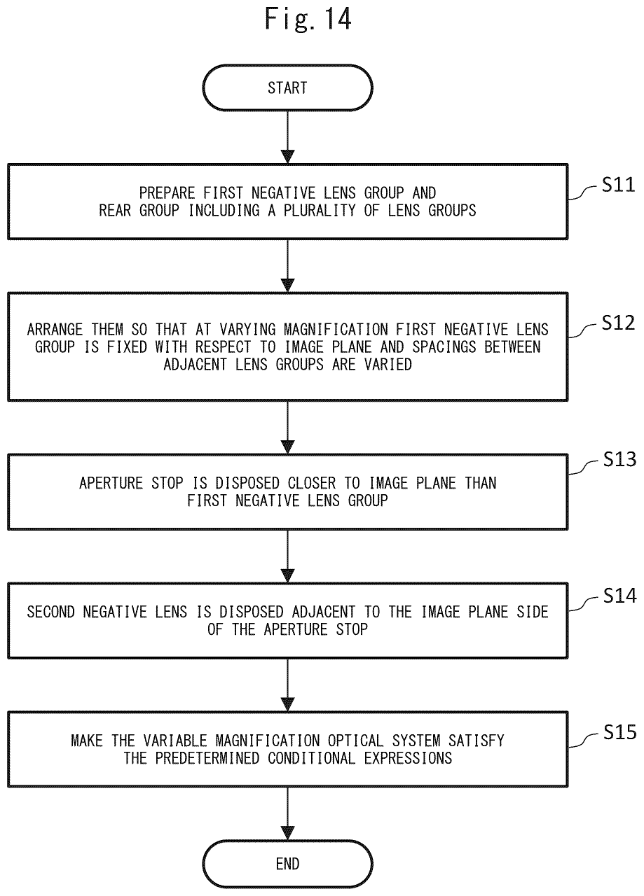

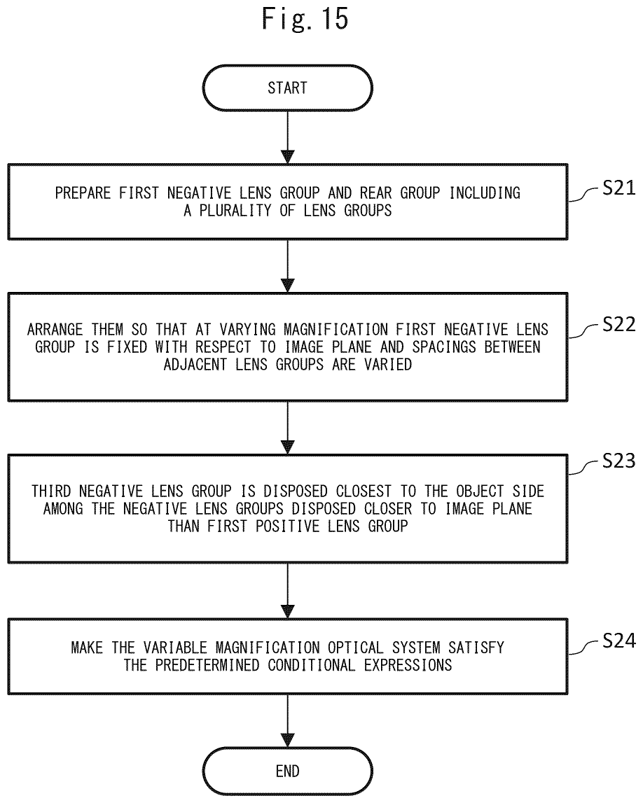

Finally, a method for manufacturing a variable magnification optical system of the present embodiment will be outlined with reference to FIG. 14 and FIG. 15.

FIG. 14 is a flowchart outlining a first method for manufacturing a variable magnification optical system of the present embodiment. The first method for manufacturing a variable magnification optical system of the present embodiment shown in FIG. 14 includes steps S11 to S15 below.

Step S11: a first negative lens group and a rear group including a plurality of lens groups are prepared.

Step S12: they are arranged so that at varying magnification, the first negative lens group is fixed with respect to the image plane, and the spacings between adjacent lens groups are varied.

Step S13: an aperture stop is disposed closer to the image plane than the first negative lens group.

Step S14: a second negative lens group among the plurality of lens groups included in the rear group is disposed adjacent to the image plane side of the aperture stop.

Step S15: the variable magnification optical system is made to satisfy the following conditional expression.

0.00<fA/fCα<0.30 (1-1)

where
fA: the focal length of the first negative lens group
fCα: the focal length of the second negative lens group

FIG. 15 is a flowchart outlining a second method for manufacturing a variable magnification optical system of the present embodiment. The second method for manufacturing a variable magnification optical system of the present embodiment shown in FIG. 15 includes steps S21 to S25 below.

Step S21: a first negative lens group and a rear group including a plurality of lens groups are prepared.

Step S22: they are arranged so that at varying magnification, the first negative lens group is fixed with respect to the image plane, and the spacings between adjacent lens groups are varied.

Step S23: the third negative lens group among one or more lens groups having negative refractive power disposed closer to the image plane side than the first positive lens group having the positive refractive power and disposed closest to the object side in the plurality of lens groups included in the rear group is disposed closest to the object side.

Step S24: The variable magnification optical system is made to satisfy the following conditional expression.

0.00<fA/fCβ<0.30 (1-2)

where
fA: the focal length of the first negative lens group
fCβ: the focal length of the third negative lens group

An optical system of favorable imaging performance can be manufactured by these methods for manufacturing methods of the variable magnification optical system of the present embodiment.

It should be noted that those skilled in the art can make various changes, substitutes, and modifications without departing from the spirit and scope of the present disclosure.

What is claimed is:

1. A variable magnification optical system comprising, in order from the object side, a first negative lens group having negative refractive power and a rear group including a plurality of lens groups,
at varying magnification, the first negative lens group being fixed with respect to the image plane and the spacings between adjacent lens groups being varied,
an aperture stop being disposed closer to the image plane side than the first negative lens group,
a second negative lens group disposed adjacent to the image plane side of the aperture stop among the plurality of lens groups included in the rear group having negative refractive power,
the variable magnification optical system satisfies the following conditional expression:
0.00<fA/fCα<0.30
where
fA: the focal length of the first negative lens group
fCα: the focal length of the second negative lens group.

2. The variable magnification optical system according to claim 1, wherein at least one lens group among the lens groups disposed closer to the image plane side than the second negative lens group moves at focusing.

3. The variable magnification optical system according to claim 1, wherein the following conditional expression is satisfied:
0.90<MVGCα/MVGE<1.50
where
MVGCα: the amount of movement of the second negative lens group focusing on infinity at varying magnification from the wide-angle end to the telephoto end
MVGE: the amount of movement of the final negative lens group having the negative refractive power disposed closest to the image plane among the plurality of lens groups included in the rear group focusing on infinity at varying magnification from the wide-angle end to the telephoto end.

4. The variable magnification optical system according to claim 1, wherein the second negative lens group has a positive lens Cαp satisfying the following conditional expression:
0.020<PgFCαp−0.64435+0.00168*νdCαp
where
PgFCαp: the partial dispersion ratio of the positive lens Cαp defined by the following expression:
PgFCαp=(ngCαp−nFCαp)/(nFCαp−nCCαp)
where ngCαp, nFCαp, and nCCαp denote the refractive indices of the positive lens Cαp at g-line, F-line, and C-line, respectively
νdCαp: the Abbe number based on d-line of the positive lens Cαp.

5. The variable magnification optical system according to claim 1, wherein the following conditional expression is satisfied:
0.045<fw/(−fCα)<0.140
where
Fw: the focal length of the variable magnification optical system at wide-angle end state.

6. The variable magnification optical system according to claim 1, wherein a lens group disposed between the first negative lens group and the aperture stop has positive combined refractive power in the wide-angle end state.

7. The variable magnification optical system according to claim 1, wherein the following conditional expression is satisfied:
0.30<STLw/TLw<0.50
where
STLw: the distance on the optical axis from the aperture stop to the image plane in the wide-angle end state
TLw: the distance on the optical axis from the lens surface closest to the object to the image plane in the wide-angle end state.

8. A variable magnification optical system comprising, in order from the object side, a first negative lens group having negative refractive power, and a rear group including a plurality of lens groups,
at varying magnification, the first negative lens group being fixed with respect to the image plane and the spacings between adjacent lens groups being varied,
a third negative lens group being disposed closest to the object side among one or more lens groups having negative refractive power and disposed closer to the image plane side than the first positive lens group having positive refractive power and disposed closest to the object side in the plurality of lens groups included in the rear group,
the variable magnification optical system satisfies the following conditional expression:
0.00<fA/fCβ<0.30
where
fA: the focal length of the first negative lens group
fCβ: the focal length of the third negative lens group.

9. The variable magnification optical system according to claim 8, wherein at least one lens group among the lenses disposed closer to the image plane side than the third negative lens group moves at focusing.

10. The variable magnification optical system according to claim 8, wherein the following conditional expression is satisfied:
0.90<MVGCβ/MVGE<1.50
where
MVGCβ: the amount of movement of the third negative lens group focusing on infinity at varying magnification from the wide-angle end state to the telephoto end state
MVGE: the mount of movement of the final negative lens group focusing on infinity at varying magnification from the wide-angle end state to the telephoto end state.

11. The variable magnification optical system according to claim 8, wherein the second negative lens group has a positive lens Cβp satisfying the following conditional expression:
0.020<PgFCβp−0.64435+0.00168*νdCβp
where
PgFCβp: the partial dispersion ratio of the positive lens Cβp, defined by the following expression:
PgFCβp=(ngCβp−nFCβp)/(nFCβp−nCCβp)
where ngCβp, nFCβp, and nCCβp denote the refractive indices of the positive lens Cβp at the g-line, the F-line, the C-line, respectively
νdCβp: the Abbe number based on d-line of the positive lens Cβp.

12. The variable magnification optical system according to claim 8, wherein the following conditional expression is satisfied:
0.045<fw/(−fCβ)<0.140
where
Fw: the focal length of variable magnification optical system in the wide-angle end state.

13. The variable magnification optical system according to claim 1, wherein the plurality of lens groups included in the rear group include a first positive lens group having positive refractive power and disposed closest to the object side and a second positive lens group having positive refractive power and disposed adjacent to the image plane side of the first positive lens group, and the following conditional expression is satisfied:
1.40<fB1/fB2<3.00
where
fB1: the focal length of the first positive lens group
fB2: the focal length of the second positive lens group.

14. The variable magnification optical system according to claim 1, wherein the following conditional expression is satisfied:
1.00<−fA/fARw<1.60
where
fARw: the combined focal length of the rear group in the wide-angle end state.

15. The variable magnification optical system according to claim 1, wherein the following conditional expression is satisfied:
0.50<fA/fE<1.20
where
fE: the focal length of the final negative lens group having the negative refractive power disposed closest to the image among the plurality of lens groups included in the rear group.

16. The variable magnification optical system according to claim 1, wherein two lens groups having positive refractive power among the plurality of lens groups included in the rear group move at focusing, and the following conditional expression is satisfied:
0.40<fF1/fF2<1.20
where
fF1: the focal length of a lens group on the object side of the two lens groups
fF2: the focal length of a lens group on the image plane side of the two lens groups.

17. The variable magnification optical system according to claim 1, wherein the following conditional expression is satisfied:
0.60<MVF1w/MVF2w<1.70
where
MVF1w: the amount of movement of a lens group on the object side of two lens groups moving at focusing among the plurality of lens groups included in a rear group at focusing from infinity to nearby in the wide-angle end state
MVF2w: the amount of movement of the lens group on the image plane side of two lens groups moving at focusing among the plurality of lens groups included in the rear group at focusing from infinity to nearby in the wide-angle end state.

18. The variable magnification optical system according to claim 1, wherein the following conditional expression is satisfied:
0.40<MVGO/MVGE<0.80
where
MVGE: the amount of movement of the final negative lens group having negative refractive power disposed closest to the image plane among the plurality of lens groups included in the rear group at varying magnification from the wide-angle end state to the telephoto end state at focusing on infinity
MVGO: the amount of movement of the lens group disposed adjacent to the object side of the final negative lens group among the plurality of lens groups included in the rear group at varying magnification from the wide-angle end state to the telephoto end state at focusing on infinity.

19. The variable magnification optical system according to claim 1, wherein the following conditional expression is satisfied:
0.40<BFw/fw<0.60
where
Bfw: the back focal length of the variable magnification optical system in the wide-angle end state
Fw: the focal length of variable magnification optical system in the wide-angle end state.

20. The variable magnification optical system according to claim 1, wherein the following conditional expression is satisfied:
−3.00<(L1R2+L1R1)/(L1R2−L1R1)<−1.00
where
L1R1: the radius of curvature of the object-side lens surface of the lens disposed closest to the object side
L1R2: the radius of curvature of the image-plane-side surface of the lens disposed closest to the object side.

21. The variable magnification optical system according to claim 1, wherein the following conditional expression is satisfied:
0.00<(LLR2+LLR1)/(LLR2−LLR1)<2.00
where
LLR1: the radius of curvature of the object-side surface of the lens disposed closest to the image plane side
LLR2: the radius of curvature of the image-plane-side surface of the lens disposed closest to the image plane side.

22. The variable magnification optical system according to claim 1, wherein the following conditional expression is satisfied:
68°<2ωw
where
2ωw: the total field angle of the variable magnification optical system in the wide-angle end state.

23. The variable magnification optical system according to claim 1, wherein the following conditional expression is satisfied:
2ωt<40°
where
2ωt: the total field angle of the variable magnification optical system in the telephoto end state.

24. An optical device comprising the variable magnification optical system according to claim 1.

25. A method for manufacturing a variable magnification optical system, the method comprising configuring a variable magnification optical system including, in order from the object side, a first negative lens group having negative refractive power and a rear group including a plurality of lens groups so that
at varying magnification, the first negative lens group being fixed with respect to the image plane and the spacings between adjacent lens groups being varied,
an aperture stop being disposed closer to the image plane side than the first negative lens group,
a second negative lens group disposed adjacent to the image plane side of the aperture stop among the plurality of lens groups included in the rear group having negative refractive power, and
the following conditional expression is satisfied:
0.00<fA/fCα<0.30
where
fA: the focal length of the first negative lens group
fCα: the focal length of the second negative lens group.
